(19) United States
(12) Patent Application Publication
(10) Pub. No.: US 2009/0262356 A1
(43) Pub. Date: Oct. 22, 2009

(54) USER INTERFACE AND METHOD FOR USING AN SPR SYSTEM

(75) Inventors: Paul Boeschoten, Redmond, WA (US); Christina Boozer, Seattle, WA (US); Pietro Brandani, Sayville, NY (US); John Cabrer, Fullerton, CA (US); Michael Cicirelli, Kirkland, WA (US); Shuxin Cong, Bellevue, WA (US); Larry Gill, Bothell, WA (US); Keith Hoffman, Lake Stevens, WA (US); Gibum Kim, Placentia, CA (US); Timothy M. Londergan, Seattle, WA (US); Frank Metting, Bothell, WA (US); R. Todd Schwoerer, Edmonds, WA (US); Markus Tarin, Temecula, CA (US); Christopher A. Wiklof, Everett, WA (US); Yang Zhang, Mercer Island, WA (US)

Correspondence Address: GRAYBEAL JACKSON LLP, 155 - 108TH AVENUE NE, SUITE 350, BELLEVUE, WA, 98004-5973, US

(73) Assignee: PLEXERA, LLC, Oriental, NC (US)

(21) Appl. No.: 12/413,494

(22) Filed: Mar. 27, 2009

Related U.S. Application Data
(60) Provisional application No. 61/072,333, filed on Mar. 27, 2008.

(51) Int. Cl. G01N 21/55; G06F 15/00

(52) U.S. Cl. 356/445; 702/127

(57) ABSTRACT

According to an embodiment, an SPR analysis system includes an SPR analysis system control computer program having a graphical user interface and configured to control the operation of an SPR analysis apparatus. According to an embodiment, an SPR data analysis computer program includes an SPR microarray video viewer and a sensorgram generator responsive to the SPR video.

### CROSS REFERENCE TO RELATED APPLICATIONS

This application claims priority benefit under 35 U.S.C. § 119(e) from, and to the extent not inconsistent with this application, incorporates by reference herein U.S. Provisional Patent Application Ser. No. 61/072,333; filed Mar. 27, 2008; entitled “SURFACE PLASMON RESONANCE SYSTEM AND APPARATUS FOR INTERROGATING A MICROARRAY”; invented by Paul Boeschoten, R. Todd Schwoerer, Michael Cicirelli, Timothy Londergan, Christopher A. Wiklof, Sunny Zhang, Frank Metting, Keith Hoffman, Shuxin Cong, Larry Gill, Markus Tarin, John Cabrer, Gibum Kim, Christina Boozer, and Pietro Brandani.

This application is related to U.S. patent application Ser. No. TBD (attorney docket number 2648-019-03); filed the same day as this application; entitled “SURFACE PLASMON RESONANCE SYSTEM AND APPARATUS FOR INTERROGATING A MICROARRAY”; invented by Paul Boeschoten, Christina Boozer, Pietro Brandani, Michael Cicirelli, Shuxin Cong, Larry Gill, Keith Hoffman, Gibum Kim, Timothy Londergan, Frank Metting, R. Todd Schwoerer, Christopher A. Wiklof, and Sunny Zhang.

### BACKGROUND

Surface Plasmon Resonance (SPR) phenomena may be used in conjunction with interrogation of a microarray carrying a variety of reactive or potentially reactive regions of interest (ROI)s. SPR is an advanced optical technology that measures changes in refractive index caused by the binding of molecules to a reflective surface. SPR has developed into a powerful tool in the bioanalytical field to measure binding constants—a critically important variable in understanding how effectively two biomolecular compounds bind to one another. For instance, SPR can observe how well a drug compound binds to a target molecule of interest.

SPR has the ability to generate a binding constant of a biomolecular interaction because it can measure the kinetics of the interaction. This may allow a researcher to view the moment at which an agent begins to bind, as well as when, or whether, the compounds disassociate. Such sensitivity may allow a researcher to view weak binding interactions—biomolecular interactions in which two species bind to one another, turn on a signal pathway, and quickly dissociate. The observation of these biomolecular binding events is a key element in biochemical and pharmaceutical research and development.

### Overview

According to an embodiment, an SPR analysis system may include a computer system running an apparatus control application having a graphical user interface and an SPR analysis apparatus operatively coupled to the computer system and configured to receive operational commands.

According to an embodiment an SPR analysis system may include an SPR analysis apparatus including an electronics module configured to receive commands from an apparatus control software application running on an operatively coupled computer, control a fluidics module and an SPR optics module responsive to the received commands, receive sensor feedback from the fluidics module and SPR optics module, and transmit status data corresponding to the sensor feedback to the apparatus control software application, wherein the application control software application is configured to presents a graphical dashboard to a user including indicators corresponding to the status data and the sensor feedback.

According to an embodiment, an SPR analysis system may include an interface to a computer system configured to run an apparatus control application including a graphical user interface.

According to an embodiment, an SPR analysis system includes a camera configured to capture a video image of at least a portion of an SPR microarray, and an SPR apparatus control software application is configured to receive the video image and display a substantially real-time image of the at least a portion of the SPR microarray to a user.

According to an embodiment, an SPR analysis system includes an SPR optical system operable to vary an SPR angle relative to a microarray. A camera receives an image from the microarray including regions of interest that may distort as a function of the SPR angle. An SPR apparatus control software package is configured to receive the video image from the camera, apply GAL overlays to the regions of interest in the video image, and modify the GAL overlay positions to compensate for the distortion in the image as the SPR angle is varied.

According to an embodiment, an SPR video image may be received by an SPR analysis software application, the SPR video image including changes in brightness in regions corresponding to regions of interest undergoing association and dissociation with at least one analyte. The SPR analysis software application may measure changes in brightness of regions of interest in the SPR video image and compute one or more kinetics parameters corresponding to the association and dissociation.

### BRIEF DESCRIPTION OF THE DRAWINGS

FIG. 1 is a perspective view of a portion of an SPR analysis apparatus, according to an embodiment.

FIG. 2A is a diagram showing physical relationships of several modules included in the SPR analysis apparatus of FIG. 1, according to an embodiment.

FIG. 2B is a view of a waste bottle with fluid level sensor from the SPR analysis apparatus of FIGS. 1 and 2A, according to an embodiment.

FIG. 3 is a block diagram of an SPR analysis system including the SPR analysis apparatus of FIGS. 1 and 2A, according to an embodiment.

FIG. 4 is a diagram of a prism mounting assembly used in the optics system of FIG. 3, according to an embodiment.

FIG. 5A is a view of a flow cell module corresponding to the SPR analysis apparatus of FIGS. 1 and 2A, according to an embodiment.

FIG. 5B is a view of the flow cell module of FIG. 5A showing a coupling to a flow cell carrier, and a flow cell carrier coupling to a flow cell, according to an embodiment.

FIG. 6 is a module diagram of an apparatus control software application that may be run on a computer system to operate the SPR analysis apparatus of foregoing figures, according to an embodiment.

FIG. 7 is a module diagram of a data analysis software application that may be run on a computer system to analyze data from and interface with an SPR analysis apparatus, according to an embodiment.

FIG. 8 is a module diagram of a data analysis application for analyzing SPR data from an SPR analysis apparatus, according to another embodiment.

FIG. 9 is a diagram illustrating the organization of a collection of spots on a microarray in conjunction with a data analysis application using hierarchical classes, according to an embodiment.

FIG. 10 is a screen shot of the main menu for the data analysis application software diagrammatically shown in FIGS. 7 and 8, according to an embodiment.

FIG. 11 is a flow chart showing workflow for the refractive index (RI) standard curve module accessible from the main menu of FIG. 10 of the data analysis application software diagrammatically shown in FIGS. 7 and 8, according to an embodiment.

FIG. 12 is a screen shot of an SPR data analysis application video setup screen with a video file opened, according to an embodiment.

FIG. 13 is a screen shot of an SPR data analysis application video setup screen showing spot selection, with a selected spot highlighted and its identifying data given, according to an embodiment.

FIG. 14 is a partial screen shot of an SPR data analysis application frame data screen, showing a reagent table, analyte table, and method builder table, according to an embodiment.

FIG. 15 is a screen shot of an SPR data analysis application spot details screen illustrating measurement configuration and SPR response curves from a partially played video file, according to an embodiment.

FIG. 16A is a first portion of a flow chart indicating work flow for using an SPR test apparatus, including control of the apparatus from an SPR apparatus control application running on a computer system shown in FIG. 3 and represented by the module diagram of FIG. 6, according to an embodiment.

FIG. 16B is a second portion of the flow chart of FIG. 16A, according to an embodiment.

FIG. 16C is a third portion of the flow chart of FIGS. 16A and 16B, according to an embodiment.

FIG. 16D is a fourth portion of the flow chart of FIGS. 16A, 16B, and 16C, according to an embodiment.

FIG. 17 is a screen shot of an apparatus setup screen of the apparatus control software program, according to an embodiment.

FIG. 18 is a screen shot of a method setup screen of the apparatus control software program, according to an embodiment.

FIG. 19 is a screen shot of a load instrument/initial system priming screen of the apparatus control software program, according to an embodiment.

FIG. 20 is a screen shot of a load/prime flow cell screen of the apparatus control software program, according to an embodiment.

FIG. 21 is a screen shot of a spot or ROI selection screen of the apparatus control software program, according to an embodiment.

FIG. 22 is a screenshot of the SPR curves & parking angle screen of the apparatus control software program, according to an embodiment.

FIG. 23 is a screenshot of an assign ROI screen of the apparatus control software program, according to an embodiment.

FIG. 24 is a screenshot of a run screen of the apparatus control software program, according to an embodiment.

### DETAILED DESCRIPTION

The following discussion is presented to enable a person skilled in the art to make and use the claimed invention. Various modifications to the disclosed embodiments will be readily apparent to those skilled in the art, and the generic principles herein may be applied to other embodiments and applications without departing from the spirit and scope of the present invention as defined by the appended claims. Thus, the present invention is not intended to be limited to the embodiments shown, but is to be accorded the widest scope consistent with the principles and features disclosed herein.

In the following detailed description, reference is made to the accompanying drawings, which form a part hereof. In the drawings, similar symbols typically identify similar components, unless context dictates otherwise. Other embodiments may be used and/or and other changes may be made without departing from the spirit or scope of the disclosure.

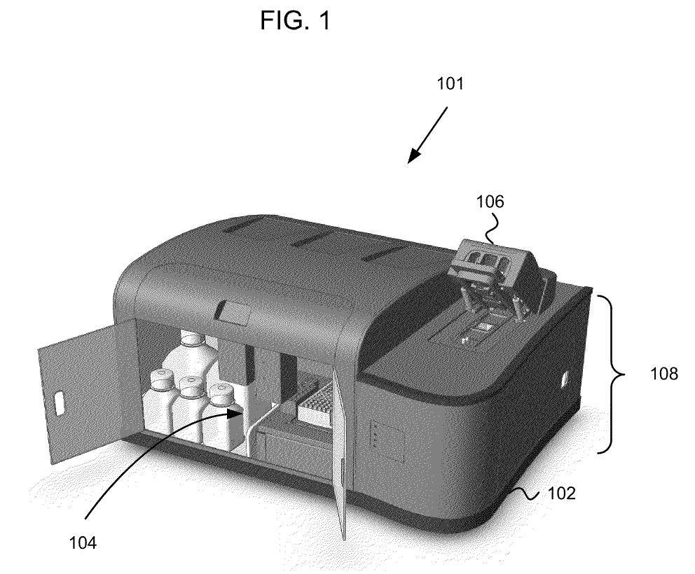

FIG. 1 is a perspective view of an SPR analysis apparatus 101, according to an embodiment. The SPR analysis apparatus 101 includes a housing 102; a fluid supply volume 104 substantially enclosed within the housing 102; a flow cell module 106 configured to receive reagents and analyte from the fluid supply volume 104; and an enclosed optics module 108 configured to interrogate a microarray (not shown) held by a flow cell module 106.

The SPR analysis apparatus 101 is configured to detect and/or characterize molecular binding interactions in a label-free format. The optics assembly 108 may simultaneously address thousands of spots on the microarray. Each spot may provide sensitivity to a particular chemical or biochemical binding event. The first component of the binding pair (also referred to as a ligand) is typically immobilized on the microarray and the second component of the binding pair, typically referred to as an analyte, is flowed past the microarray through a flow cell volume. Typically, the second component of the binding pair may be pumped from a microwell via the autosampler. The chemical binding pairs may include, for example, an antigen-antibody pair, a peptide-peptide pair, a protein-DNA pair, a protein-RNA pair, or complementary strands of DNA or RNA.

The SPR analysis apparatus 101 may be used to determine a range of scientifically valuable observations. For example, specificity of binding pairs may be used to identify unknown molecules in a sample. Kinetic rate parameters, such as an association constant (kₐ) that characterizes association of an analyte with a ligand and a dissociation constant (k_{d}) that characterizes dissociation of an analyte from a ligand may be determined. Binding affinity, e.g., the strength of the binding interactions, such as may be characterized by an equilibrium constant Ka=kₐ/k_{d} may also be determined.

The SPR analysis apparatus 101 may provide label-free detection. In contrast to other systems that use tagged molecules, label-free detection may use an unaltered analyte. This may be useful compared to labeled systems in that steric hinderance, binding affinities, and other functional aspects of the analyte are typically not altered by the addition of a molecular tag. Especially in the case of unknown analytes, label-free detection also allows detection of unknown molecules without requiring a priori functionalization or otherwise reacting the unknown molecules to add molecular tags.

The SPR analysis apparatus 101 may also be configured to provide high-throughput analysis with up to or greater than about 5,000 simultaneous data points per run. The high-throughput may be leveraged to provide high-content analysis with up to 5,000 unique ligands per microarray. That is, the system 101 may be configured to interrogate microarrays with each ROI holding a unique ligand having a corresponding unique affinity for analytes.

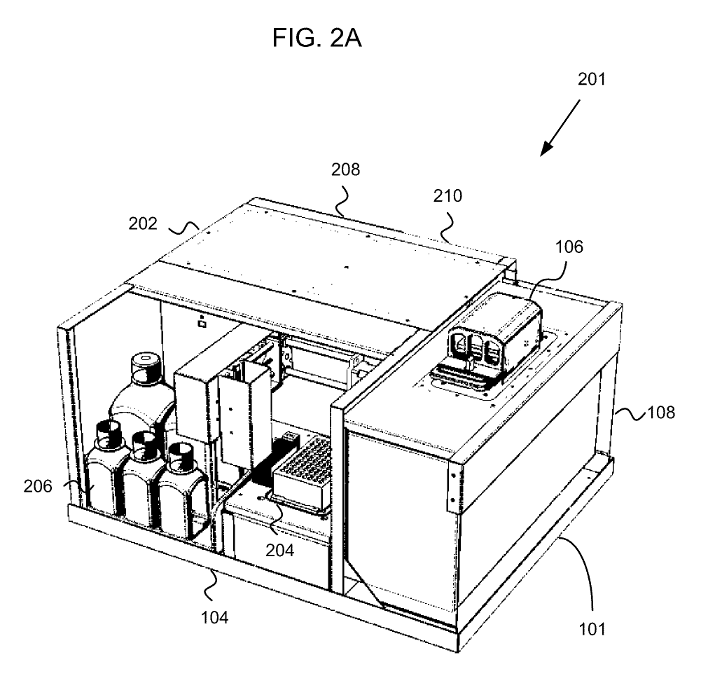

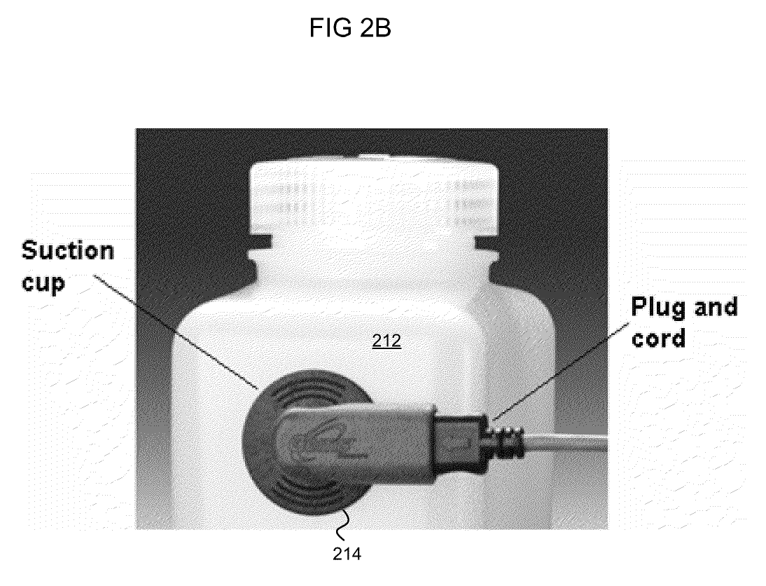

FIG. 2A is a view 201 showing physical relationships of several modules included in the SPR analysis apparatus 101 of FIG. 1 with the housing 102 removed, according to an embodiment. The SPR analysis apparatus 101, 201 includes an inner housing 202; a fluid supply volume 104 including an autosampling apparatus 204 and at least one reagent reservoir 206 within an accessible portion of the inner housing 202; an enclosed electronics module 208 within the inner housing; an enclosed fluidics module 210 within the inner housing, configured to selectively draw fluids from the autosampling apparatus 204 and the at least one reagent reservoir 206 in the fluid supply volume 104, responsive to signals from the electronics module 208; a flow cell module 106 configured to receive fluid flow from the fluidics module 210; and an enclosed optics module 108 operatively coupled to the electronics module 208 and configured to interrogate a microarray portion (not shown) of the flow cell module 106 responsive to signals received from the electronics module 208.

An electronics module 208 includes a microprocessor and/or microcontroller, memory, communications hardware, sensor interfaces, driver electronics, a power supply, and other components configured to interface with other portions of the SPR analysis apparatus 101, 201.

FIG. 2B is a view of a waste bottle with fluid level sensor from the SPR analysis apparatus of FIGS. 1 and 2A, according to an embodiment. The fluid supply volume 104 includes a volume for receiving at least one waste container 212. A non-contact fluid level sensor may be operatively coupled to the electronics module 208. The non-contact fluid level sensor is adapted for coupling to the at least one waste container 212, and configured to transmit a characteristic signal to the electronics module 208 when a waste fluid volume in the waste container 212 reaches a level. Accordingly, the system 101 is configured to prevent spills and potential damage that could be caused by overflowing the waste container 212.

The fluid supply volume 104 includes room for seven reagent bottles 206 (FIG. 2B) connected to the fluidics module 210. These include cleaning solution (detergent), waste, running buffer, water, and three regeneration solutions. The reagent bottles are located in a tray to the left of the autosampler. There are color-coded labels provided with the apparatus 101, 201 to allow a user to label reagent bottles to match tubing to reagent bottles. The name, location, and preparation date of reagents may be manually entered for each reagent using a Method Setup function of apparatus control software. Reagent bottle caps and tubing are colored and labeled with port numbers.

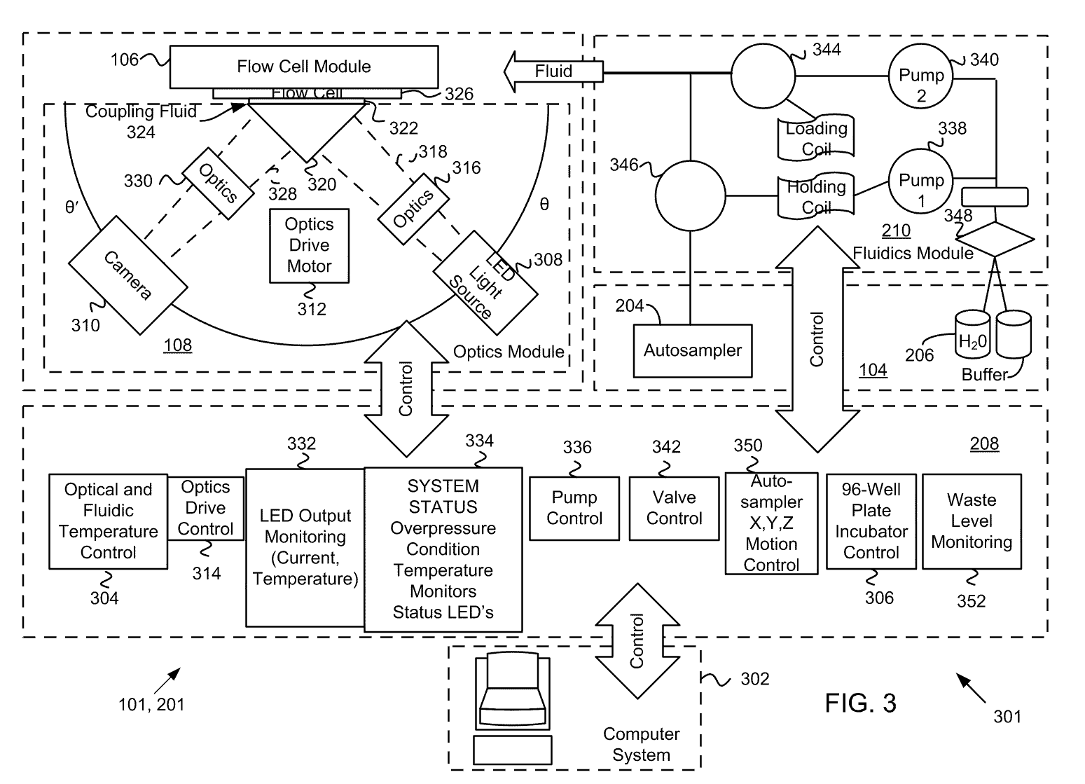

FIG. 3 is a block diagram of an SPR analysis system 301 including the SPR analysis apparatus 101 of FIGS. 1 and 2A, according to an embodiment. The SPR analysis system 301 may include a computer system 302 configured to run an apparatus control application (not shown) having a GUI interface. The SPR analysis apparatus 101 is operatively coupled to the computer system via the electronics module 208.

The electronics module 208 includes control circuitry coupled to receive control data from the computer system 302 and responsively control other portions of the SPR analysis apparatus 101, including an autosampler 204, a fluidics module 210, and an optics module 108. The electronics module 208 may include a conventional microprocessor-based controller including memory (e.g., RAM, ROM, etc.), a microprocessor, input/output circuitry, user interface hardware, one or more ASICs, one or more gate arrays or FPGAs, programmable array logic (e.g., PAL, etc.), one or more analog-to-digital converters, one or more digital-to-analog converters, one or more motor drivers, one or more sensor interfaces, and/or other devices in operative communication via one or more buses and physically connected using a printed circuit board.

The electronics module 208 of the SPR analysis apparatus 101, 201 includes one or more thermal control modules 304 for one or more of the flow cell modules 106 and the optics module 108. A second thermal control module 306 (which may optionally be integrated with the thermal control module 304) may provide temperature control for the well plate sample array of the autosampler 204. SPR operates by measuring the response of photon reflectivity vs. conversion from photons to surface plasmons responsive to small variations in local refractive index that result from binding (or not) and unbinding of an analyte from an immobilized ligand. Since the refractive index of fluids typically varies according to temperature, accurate and precise temperature control may be important.

Typically, one or more thermocouples, thermisters, or other temperature measurement apparatuses may be located in thermal contact with components of each of the flow cell 106, optics module 108, and well plate of the autosampler 204. The autosampler 204 well plate and the flow cell 106 may be thermostatically controlled to common desired fluid temperature. Alternatively, the autosampler 204 well plate may be controlled to a temperature that is offset from the flow cell 106 to compensate for systematic changes in temperature during delivery of the fluids from the well plate to the flow cell. Optionally, the autosampler 204 pipet, tubing and/or components in the fluidics module 210, other reagents 206 in the fluid supply volume 104, and tubing between the fluidics module 210 and flow cell module 106 may include temperature measurement and/or control apparatuses that are controlled by a thermal control module 304 and/or 306. The optics module 108 may be thermostatically controlled to maintain the same temperature as the flow cell module 106. According to an embodiment, the optics module 108 may be thermostatically controlled to a temperature slightly higher than the temperature of the fluids, for example 1° to 2° Celsius higher than the temperature of the fluids in the flow cell 326, to avoid condensation on optical surfaces.

The thermal control modules 304 and 306 may operate to heat and/or cool the autosampler 204, flow cell module 106, and optics module 108. For example, for operation above ambient temperature, thermal control may be performed by selectively heating components. According to an embodiment, a thermo-electric (TE) heater/cooler may be used to heat or cool the components. In some cases, energy from the light source 308 may provide radiant heating of the optics module 108 and/or the flow cell module 106. In cases where radiant heating is significant, at least some surfaces may be cooled while other surfaces are heated. For example, the autosampler 204 sample well may be heated, and the flow cell module 106 may be cooled to maintain a consistent temperature between the components. As an alternative to local TE heating/cooling, the flow cell module 106 and/or other temperature-controlled components may be heated or cooled by a circulating fluid that is maintained at a controlled temperature by a remote temperature control apparatus that is controlled by temperature control module or modules 304 and/or 306.

Three TE heater/coolers are respectively located above the flow cell in the flow cell module 106, beneath the well plate in the autosampler 204, and in the optics compartment 108. Temperature values may be set between 4° C. and 40° C. using a method setup function in an apparatus control software application running on the computer 302. To ensure the samples and buffer entering the flow cell are at the same temperature, tubing between the injection valve 346 and the flow cell 326 has a thin lining and is constructed from a heat-conducting material. All fluids are first circulated through this tubing along the TE heater/cooler before entering the flow cell 326.

A TE heater/cooler located in the optics compartment 108 may speed up system warm-up time. If the system is turned on from a cold state, the optical components such as the camera and LED light source will heat up until they reach equilibrium. The heater speeds the process of reaching temperature equilibrium, which is necessary for a stable baseline.

The optics module 108, including a light source 308, a camera 310, and one or more drive motors 312 are controlled by an optics drive control module 314 in the electronics module 208. The light source 308 and collimation and/or polarizing optics 316 are configured to provide substantially collimated illumination 318. An optical coupler 320, which may be a flat or curved surface prism having an optical coupler refractive index, for example, is aligned to receive the illumination beam 318. The optical coupler 320 couples rays of the beam 318 to corresponding points on an SPR coupling surface (not shown) of a microarray 322. Optionally, a coupling fluid, gel, or film 324 is disposed between the optical coupler 320 and the microarray 322 to eliminate air surfaces and reduce corresponding insertion losses. The one or more drive motors 312 drive the light source 308 and camera 310 to respective incident and reflection angles θ and θ′, which nominally are set equal to one another.

U.S. patent application Ser. No. 11/562,197 (attorney docket number 2648-005-03), entitled “SURFACE PLASMON RESONANCE SPECTROMETER WITH AN ACTUATOR DRIVE ANGLE SCANNING MECHANISM”, invented by Hann-Wen Guan, et al., filed Nov. 21, 2006, is to the extent not conflicting with this disclosure, incorporated by reference herein. This application includes information about angle control and actuation of an SPR optics module 108, according to an embodiment.

Typically, the microarray 322 includes a substrate (not shown) having a substrate refractive index, the substrate supporting the SPR coupling surface. Typically, the SPR coupling surface is a thin metal film, often gold, that is thin enough for an evanescent wave portion of the impinging beam to penetrate through to a region extending about 200 μM above the top surface of the SPR coupling surface. (The orientation of the optics module 108, the microarray 322, and the flow cell module 106 may be reversed, rotated, or may otherwise differ from the depiction of FIG. 3. For simplicity, description herein is based on a microarray lying above the optical coupler 320.) The upper surface of the SPR coupling surface is assembled with a flow cell 326 to maintain contact with fluids pumped through the flow cell by the fluidics module 210.

Ligands are typically covalently bound to the upper surface of the SPR coupling surface (or to one or more binding layers such as a thin layer of titanium, titanium dioxide, and/or a self-assembled monolayer (SAM)) in a pattern of regions of interest (ROIs). The ligands include functionalized portions that preferentially bind to one or more analytes or potential analytes, the ligands and the functionalized portions typically lying well within the evanescent wave penetration. For example, a first ligand located in a first ROI may preferentially bind to a first protein or other molecule, (first analyte) and a second ligand located in a second ROI may preferentially bind to a second protein or other molecule (second analyte). When the first analyte is present in fluid flowing through the flow cell 326 over the surface of the microarray 322, at least a portion of the first analyte binds to the first ligand in the first ROI. If the second analyte is missing from the fluid, then substantially no binding to the second ROI may occur. The presence of the first analyte bound to the first ROI typically lowers the refractive index in the region of the evanescent penetration, while the lack of the second analyte bound to the second ROI keeps the ROI at a value similar to the bulk fluid. Rays of the beam 318 that evanescently penetrate into the region above the first ROI thus encounter a lower refractive index than rays that penetrate into the region above the second ROI. The higher refractive index of the second ROI tends to reflect the impinging photons of the beam 318. The lower refractive index of the first ROI tends to cause conversion of the photons to surface plasmons, thus reducing the apparent reflectivity of the first ROI.

Since the refractive index dip is proportional to analyte loading on the ROI, the reflectivity of the ROIs (e.g. in steady state) may indicate an analyte presence or concentration in the fluid. Similarly, the reflectivity may be monitored vs. time to detect the rate of analyte binding characterized by an association constant kₐ or a rate of analyte unbinding characterized by a dissociation constant k_{d}. Similarly, the reflectivity of the ROI may indicate an equilibrium constant Ka=kₐ/k_{d}.

The intensity of reflected rays may be modulated according to the local indices of refraction within regions of interest (ROIs) (not shown) on the top surface of the SPR coupling surface of the microarray 322. Reflected light 328 is then launched from the optical coupler 320 through imaging optics 330 to a detector 310. According to an embodiment, the detector 310, which may be referred to as a camera, may include a focal plane detector such as a charge-coupled device (CCD) or complementary metal-oxide semiconductor (CMOS) imager array. The camera 310 outputs a corresponding detection signal or detection data (not shown) such as an electrical detection signal or detection data that is transmitted to the electronics module 208 and from the electronics module 208 to the computer system 302. According to an embodiment, signals or data from the camera 310 are passed through the electronics module 208 with minimal or no signal conditioning in order to best preserve the original reflected light values received by the camera 310.

The detection signal or data signal from the camera 310 may be processed by the computer system 302 to generate a bitmapped, vector, or other image of the reflection pattern of the SPR coupling surface of the microarray 322. According to an embodiment, the signal from the camera 310 is returned as a video data stream that is received by a video processing circuit board in the computer system 302 and managed by an SPR system control application running on the computer 302.

The precision and accuracy of the video output by the camera is a function of the stability of the light source 308. A light source monitor module 332 in the electronics module 208 monitors the status of the light source 308. The light source monitor module 332 may monitor electrical current dissipated by the light source 308, temperature of the light source 308, and/or may monitor light energy emitted by the light source, for example by using a photodiode or phototransistor coupled to a light tap. The light source monitor module 332 may provide data related to the operation of the light source 308 to the computer system 302 and/or to a user interface 334. According to an embodiment, the light source monitor module 332 may include a feedback or feed-forward control circuit, for example including a proportional-integral-differential (PID) controller, to drive the light source 308 to a constant and/or desired light output. Some embodiments include a variable-output source such as an incandescent source in the light source 308. According to an embodiment, the light source module 308 is a light-emitting diode (LED) light source configured to output a narrow wavelength range with substantially constant output. According to an embodiment the LED light source 308 may be configured to output one or more wavelengths in the red and/or infrared wavelength range. According to an embodiment, the LED light source is configured to output light at one or more of about 633, 635, 655, 670, 720, 780, 850, 880, 910, and/or 940 nanometers wavelength.

The electronics module 208 is further configured to control the movement and selection of fluids for flow through the flow cell 326. A pump control module 336 is configured to control and drive pumps 338 and 340 in the fluidics module 210. A valve control module 342 is configured to control and drive valves including a sample injection valve 344, a selection valve 346, and a reagent selector valve 348, the latter being configured to select from among reagents 206 such as buffer solution or water. An autosampler control module 350 is configured to control the autosampler 204. The fluidics subsystem 210, including approaches to its control, is described in U.S. patent application Ser. No. 12/339,017, entitled “SPR APPARATUS WITH A HIGH PERFORMANCE FLUID DELIVERY SYSTEM”, invented by Gibum Kim, et al., filed Dec. 18, 2008, and incorporated by reference herein.

The autosampler 204 is driven by the autosampler control module 350 for analyte delivery. The autosampler 204 is configured to receive a 96-well plate and has the option of loading up to eight individual (1.5 mL) microcentrifuge tubes. The autosampler 204 is also equipped with a wash station for needle cleansing and a sample cooling block located beneath the 96-well plate holder. The autosampler control module 350 automatically washes the sample injector with high-pressure water between injections.

The autosampler temperature control module 306 controls the samples in the well plate via a thermal electric cooler (TEC) located below the well plate. The temperature is set to a standard 4° C. A user may also disable the chiller by using an Apparatus Setup function in system control software running on the computer 302.

The system status module 334 of the electronics module 208 includes feedback such as pressure monitoring and monitoring of valve and pump handshaking with the respective drive modules. Based on signals and/or data received the system status module 334 may report status to the computer system 302, illuminate one or more status LEDs or other user interface apparatuses, modify operation of the other control modules 336, 342, and/or 350, or shut down the system 101, such as to prevent damage or an unsafe condition.

The system status module 334 may include status indicators such as LEDs located on the front panel of the SPR apparatus 101. A power indicator displays green when the system is turned on. A temperature indication is made by flashing the green power indicator while the system is warming up. The power indicator is lit solid green when the system is at operating temperature. A “system ready” indicator is illuminated solid green to indicate that the apparatus is ready to run a fluidic sequence. A flashing green “system ready” LED indicates that an experiment or fluidic recipe is in progress. A “system error” indicator does not illuminate during normal operation except for briefly flashing at start-up. The “system error” indicator flashes red if there is a parameter fault such as a wrong method, insufficient analyte, or waste level fault. The “system error” indicator is illuminated solid red if there is a system fault. System faults may include a disruption in a pump valve or overpressure in the fluidics module 210, a problem in the optics module 108 such as drive motor 312 fault or light source 308 temperature or current spike, or a communication error. Other interface portions include a Power Switch located on the back panel of the apparatus 101, 201 and a connection to the computer system 302. According to one embodiment, a video output and a universal serial bus (USB) connection are provided.

Finally, a waste level monitoring module 352 may be configured to monitor the amount of fluid received in a waste container 212 depicted in FIG. 2B, via a mountable sensor 214. The waste level monitoring module 352 may communicate with the system status module 334 according to data or a signal received from the sensor 214.

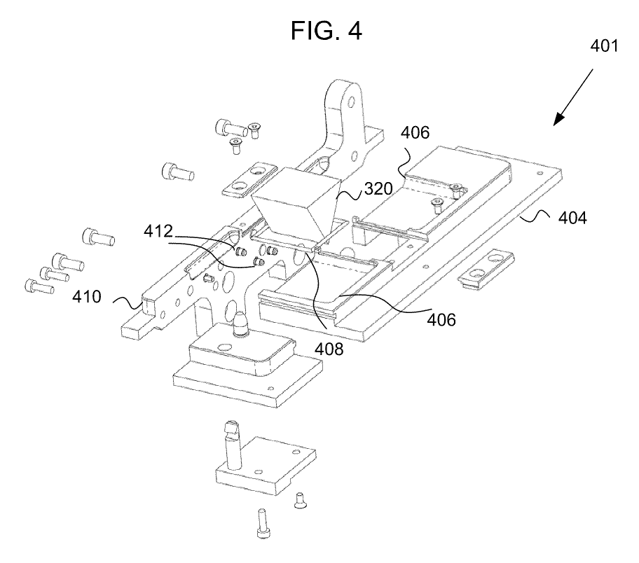

FIG. 4 is an exploded diagram of a prism mounting assembly 401 used in the optics module 108 of FIG. 3, according to an embodiment. The prism mounting assembly 401 includes a prism 320 configured to couple light from an SPR optics module 108 into a microarray as described above. A spill plate 404 is substantially sealed against the sides of the prism 402, for example with an elastomeric gasket 408 such as an O-Ring. The spill plate 404 may be configured to catch liquid spills in at least one spill well 406 to substantially prevent liquid from entering the SPR optics module 108. Thus a leak in a flow cell (not shown) will tend not to damage the sensitive components within the sealed optics module 108. The prism 402 may be mounted to a surface of the housing (not shown) via a registration frame 410 including a plurality of pins 412 aligned to register at least two lower surfaces of the prism.

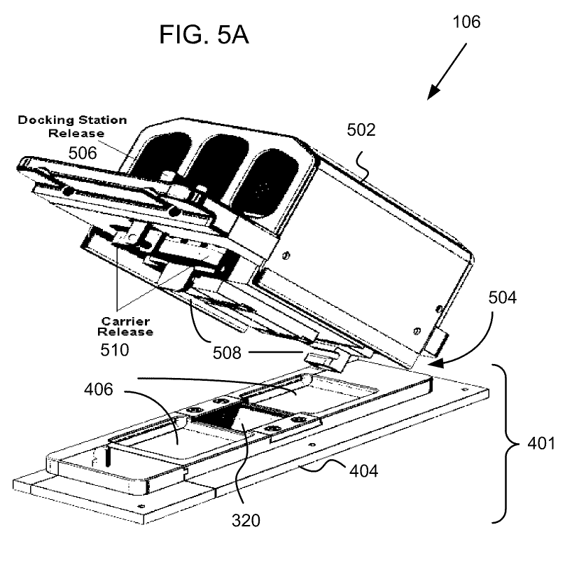

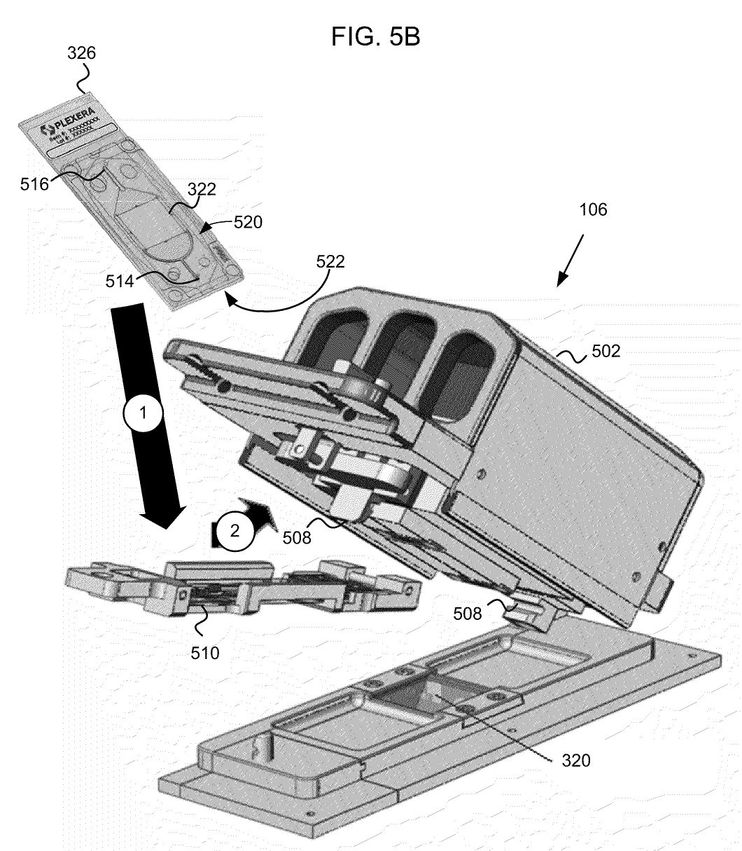

FIG. 5A is a view of a flow cell module 106 corresponding to the SPR analysis apparatus 101, 201 of FIGS. 1, 2A, and 3 and its relationship to a prism mounting assembly 401 shown in FIG. 4, according to an embodiment. FIG. 5B is a view of the flow cell module of FIG. 5A showing a coupling between a body 502 and a flow cell carrier 510, and a flow cell carrier 510 coupling to a flow cell 326, according to an embodiment. With reference to FIGS. 5A and 5B, the flow cell module 106 for the SPR analysis apparatus 101 includes a body 502 including a thermoelectric heater-cooler (not shown) configured to maintain a selected temperature of fluids received in tubing (not shown) from a fluidics module (not shown) for delivery to a flow cell 326 operatively coupled to the body 502. The body 502 includes a flow cell mounting assembly 508 configured to receive a flow cell carrier 510. The body 502 includes respective orifices (not shown) for delivering and receiving fluid to and from corresponding orifices 514, 516 in the flow cell 326. Fluid flows into the flow cell through the input orifice 514, flows across a microarray surface 322, and then flows out the outflow orifice 516.

In the flow cell module 106, the body 502 may be configured for hinged attachment 504 to a prism mounting assembly 401. As described above, the prism mounting assembly 401 may include a spill plate 404 configured to couple to a prism 320 and including at least one spill well 406. The body 502 may be configured for releasable hinged attachment 504 to a prism mounting assembly 401 and may include a body release mechanism 506 configured to release the body 502 from the prism mounting assembly 401. The flow cell mounting assembly 508 may further include a carrier release mechanism 510 configured to release the flow cell carrier 510 from the flow cell mounting assembly 508.

In the flow cell module 106, the thermoelectric heater-cooler (not shown) may be operatively coupled to an electronics module 208 of the SPR analysis apparatus 101, 201 to return at least one signal corresponding to a temperature of the flow cell 326. The thermoelectric heater-cooler (not shown) may be further configured to receive at least one signal corresponding to a command to heat or cool the fluids in the tubing (not shown) flowing to the flow cell 326 and/or to heat or cool fluids in the flow cell 326 itself.

The flow cell may be mounted in the flow cell module 106 of the SPR analysis apparatus 101, 201 by a method including coupling the flow cell 326 into a flow cell carrier 510, and coupling the flow cell carrier 510 carrying the flow cell 326 to a flow cell mounting assembly 508 of the body 502 configured to provide fluid to the flow cell 326.

Prior to mounting the flow cell 326 to the flow cell carrier 510, a top plate 520 may be assembled to a microarray 322 to form a flow cell 326 including a flow volume over the microarray 322. The assembly of the top plate 520 to the microarray 322 may be performed with a flow cell assembly jig (not shown) provided as an accessory to the SPR analysis apparatus 101, 201. The top plate 520 may be coupled to the microarray 322 using a pressure sensitive adhesive (not shown). The SPR flow cell 326 may include a substrate 522 including a microarray 322, and a top plate 520 defining a volume over the microarray 322. The top plate 520 may be joined to the substrate 522 and may include respective orifices 514, 516 for ingress and egress of fluids to and from the volume.

Conventionally, the substrate 522 of the flow cell 326 may be formed from a glass that is indexed-matched to the prism 320. According to an embodiment, the substrate 522 of the flow cell 326 may be formed substantially from a relatively low refractive index glass having a refractive index of about 1.5. In contrast, the prism 320 to which the SPR flow cell 326 may be coupled has a higher refractive index of about 1.72. The low index substrate 522 may be formed from BK-7 or Soda-Lime glass and the prism may be formed from SF-10 glass.

The substrate 522 is compatible with most microarray printers and has the dimensions 25.1 mm width, 75.4 mm length, and 1.0 mm thickness. One end of the substrate 522 has a designated area for labeling including an item number for the slide, a lot (batch) tracking number, and an area for a user to write on or affix an additional label. Each substrate is supplied with a cover slide. When stored at room temperature, the cover slides have a lifetime of over six months. When placed together, the slide and cover slide form the flow cell. The channel in the flow cell is designed to provide a fluid plug path that minimizes the effects of dispersion from one sample to the next. The flow cell 326 is described in U.S. patent application Ser. No. 11/846,883, entitled “MICROFLUIDIC APPARATUS FOR WIDE AREA MICROARRAYS”, invented by Gibum Kim, et al., filed Aug. 29, 2007; and in U.S. patent application Ser. No. 11/846,908, entitled “METHOD FOR UNIFORM ANALYTE FLUID DELIVERY TO MICROARRAYS”, invented by Gibum Kim, et al., filed Aug. 29, 2007, both of which are incorporated by reference herein.

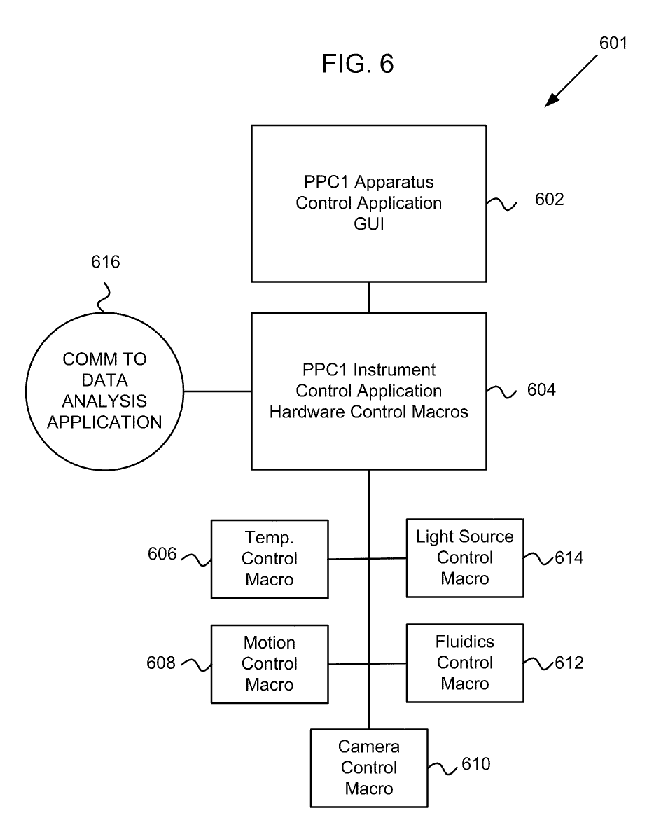

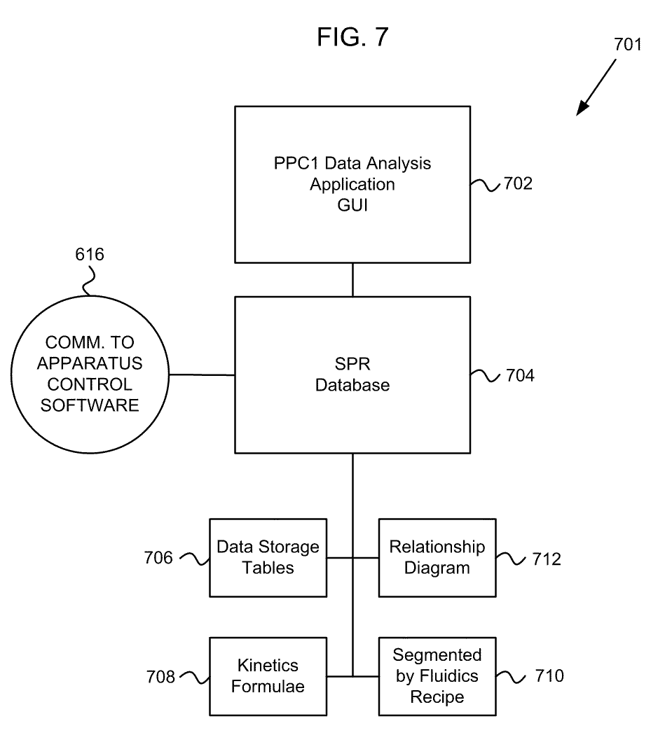

FIG. 6 is a module diagram of an apparatus control software application 601 that may be run on the computer system 302 to operate the SPR analysis apparatus 101, 201. The software application 601 may include a graphical user interface (GUI) module 602 for receiving user commands for controlling the SPR analysis apparatus 101, 201. An apparatus control module 604 may be configured to receive user commands from the graphical user interface module 602 and may be operable to transmit corresponding commands to an electronics module 208 of the SPR analysis apparatus 101, 201. The apparatus control module 604 may include some or all of at least one temperature control module 606, at least one motion control module 608, at least one camera control module 610, at least one fluidics control module 612, and at least one light source control module 614. Each of the at least one temperature control module 606, motion control module 608, camera control module 610, fluidics control module 612, and light source control module 614 may be configured to generate commands for corresponding portions of the SPR analysis apparatus 101, 201. Such commands may be generated responsive to user commands received from the graphical user interface module 602, or responsive to computer commands received from a stored workflow or otherwise generated by the apparatus control application 604. According to an embodiment, the apparatus control application 601 may further include a communications interface 616 to an SPR data analysis application 701 shown in FIG. 7.

FIG. 7 is a module diagram of a data analysis software application 701 that may be run on a computer system to analyze data from the SPR analysis apparatus 101, 201. A graphical user interface module 702 may receive user commands for analyzing data from the SPR analysis apparatus 101, 201. An SPR database module 704 may be configured to receive and respond to queries, and store data from the graphical user interface module 702. The SPR database module 704 may include one or more of at least one data storage table 706, at least one kinetics formulae module 708, at least one fluidics recipe module 710, and at least one relationship diagram module 712. The at least one fluidics recipe module 710 may be configured to store fluidics operating parameters for driving a fluidics module 210 of the SPR analysis apparatus 101, 201. Optionally, the data analysis application 701 may further include a communications interface 616 to an apparatus control application 601.

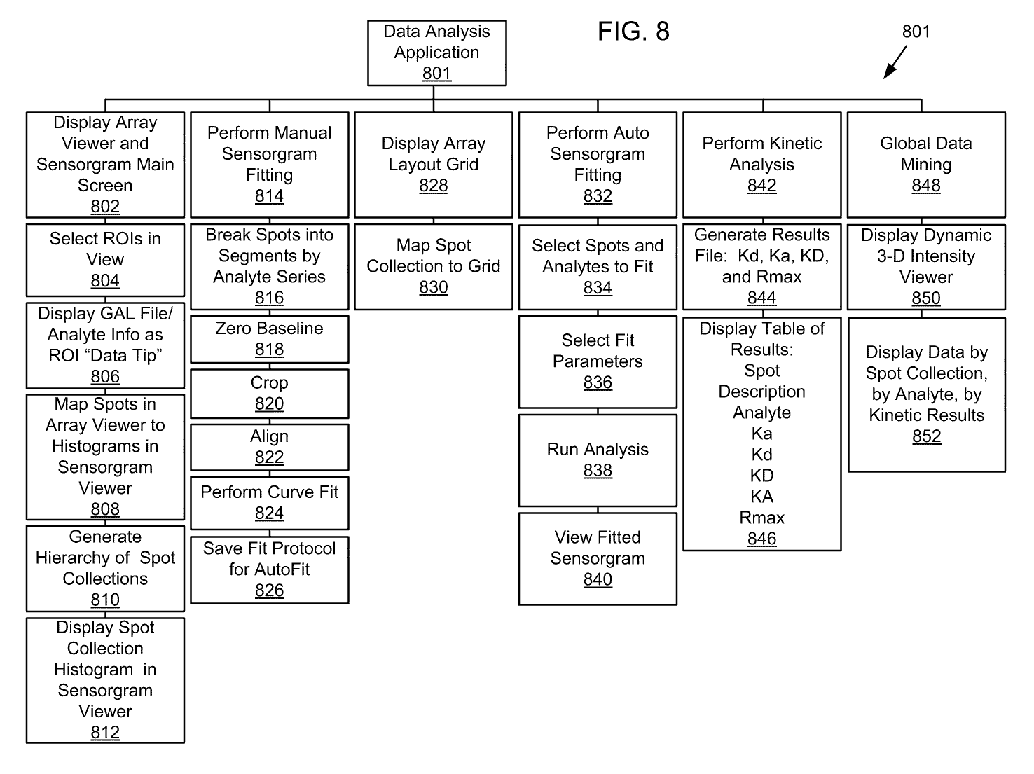

FIG. 8 is a module diagram of a data analysis application 801 according to another embodiment. The data analysis application 801 may include a video and sensorgram display module 802. The video and sensorgram display module 802 may be configured to display a video SPR image of a microarray. The SPR image of the microarray may optionally be displayed in real time responsive to video signals received from an operatively coupled camera 310 of an SPR analysis apparatus 101, 201. Optionally, the data analysis application 801 may display a previously recorded still or video SPR image of a microarray. Optionally, the main screen display module 802 may be configured to display a sensorgram corresponding to response data from one or more of a plurality of regions of interest corresponding to the video SPR image.

The video and sensorgram display module 802 may receive a previously recorded sensorgram, or alternatively may generate a sensorgram from the video image. The sensorgram may be generated by monitoring changes in brightness of one or more groups of pixels during an experimental run, the one or more groups of pixels corresponding each of one or more ROIs on a microarray. An ROI selection module 804 is operable to receive user selection of ROIs within the video display, or alternatively may automatically select ROIs for display. For example, a sensorgram showing avid binding or other significant activity in an experimental run may be identified by the SPR apparatus control software application and marked, for example as tagged information in a video file, and used to select a corresponding ROI for display in the video image. A data tip module 806 may be configured to receive data from a GenePix Array List (GAL) file, an analyte information file, and/or a microarray history file; and correlate the data to provide data tip output including identification of ROIs likely to show activity. A sensorgram mapper module 808 is configured to track changes in brightness of selected ROIs to generate sensorgram data to be displayed by the sensorgram display. A spot collection hierarchy management module 810 may be configured to generate a hierarchy of spot collections, for example based on the GAL file or output from the data tip module 806. A histogram module 812 may be configured to assemble spot collection histograms for display to the user, for example in combination with the sensorgram viewer.

A manual sensorgram fitting module 814 may be provided to allow users to manually fit data to one or more of at least one kinetics models, avid binding models, and or equilibrium models. A data segmenter module 816 receives user input to define regions for fitting. For example the user may choose data segments corresponding to different analytes of interest. Alternatively, the data segmenter module 816 may provide automatic segmentation based on data trends in a sensorgram. A baseline zeroing module 818 may receive user input or automatically normalize one or more data segments by setting a baseline to a desired value such as zero. A cropping module 820 may receive user input or automatically crop a series of data to reduce the display to an area of interest. An alignment module 822 may provide time-axis alignment of multiple data series and/or time align a data series to a curve. A curve fit module 824 may allow a user to map association and/or dissociation curves to the data. For example, curve fit module 824 may provide an associate and/or dissociation curve superimposed over the data. The user may manipulate the shape of the curve by dragging and dropping portions of the curve, spline tools, or other graphical manipulation tools to provide an “eye fit” to the data. The resultant shape of the curve may be used to generate curve parameters according to a selected kinetic model. A fit protocol module 826 may save manipulations performed by the user and/or automatically by software as auto-fit protocols. The auto-fit protocols may be subsequently be replicated in software to automate manual input from the user.

An layout grid display module 828 may be configured to display sensitivity spots (e.g. GAL overlays) over a grid corresponding to the ROIs. A spot collection mapping module 830 may be configured to map the ROIs under the sensitivity spots. The modules 828 and 830 may be further configured to receive user input and/or automatically adjust the sensitivity spots to the apparent locations of the ROIs on the grid. According to embodiments, the apparent height and vertical spacing of the ROIs may change with SPR angle. The layout grid display module 828 may be configured to automatically adjust the locations of sensitivity spots responsive to angle and/or responsive to changes in the microarray image. According to an embodiment, the layout grid display module 828 includes an image processor configured to analyze the image of the microarray and compensate for distortion. According to another embodiment, the layout grid display module 828 may calculate the positions of sensitivity spots responsive to angle data received from the SPR analysis apparatus 101, 201 and/or from the SPR analysis apparatus control software application 601. This may provide dynamic changes in measurement spot placement during angle sweeping operations.

An automatic sensorgram fitting module 832 may be configured to provide automatic fitting of a sensorgram to a curve. A spot and analyte fit selection module 834 may be configured to receive user input or may be configured to automatically determine ROIs and analytes to fit (e.g., based on output from the data tip module 806). A sensorgram fit parameter selection module 836 may be configured to receive fit parameter input from a user, or alternatively may generate sensorgram fit parameters (for example from the protocols generated by the fit protocol module 826, or from correlation to a curve shape library). A sensorgram fitting module 838 may be configured to run an analysis to fit ROI brightness data to a sensorgram curve according to parameter determined by the sensorgram fit parameter module 836. For example, the sensorgram fitting module 838 may use regression analysis to provide a best fit. A fitted sensorgram display module 840 may be configured to display a sensorgram fit curve generated by the sensorgram fitting module 838 over the sensorgram data.

A kinetic analysis module 842 may be configured to analyze the fitted sensorgram curve generated by the sensorgram fitting module 838 to determine kinetics parameter values. The kinetic analysis module 842 may be configured to receive a kinetics model selection from a user. Alternatively, the kinetic analysis module 842 may automatically determine a kinetic model. For example the kinetic analysis module 842 may be configured to receive GAL and/or analyte information, and compare the GAL and/or analyte information to reference data via a global data mining module 848 (described below) to determine a reference kinetic model to use for a ligand/analyte pair. Alternatively, the kinetic analysis module 842 may be configured to compare the fitted sensorgram curve to a curve library to determine the likelihood of a given kinetic model being the correct model, and select the most likely correct model. Alternatively, the kinetic analysis module 842 may be configured to perform kinetic analysis using a plurality of kinetic models, and determine the best fit model, for example using regression analysis.

The kinetic analysis module 842 may alternatively provide a kinetic analysis based on the sensorgram data itself, rather than on a fitted sensorgram curve. The kinetic analysis module 842 may optionally and/or selectively use analysis acceleration protocols to speed the kinetic analysis. For example, the kinetic analysis module 842 may depopulate a data set corresponding to a desired parameter accuracy. For example, if a user only needs three significant digits in a parameter (and inputs that information to the fit parameter selection module 836), the kinetic analysis module 842 may remove a portion of the input data that would not change the parameter within three significant digits.

A kinetic results generator module 844 is configured to output a kinetic analysis results file including the kinetic parameters output by the kinetic analysis module 842. A kinetic table display module 846 may be configured to assemble information from the kinetic analysis results file, a GAL file, an analyte file, and/or other data sources, and output a report including the assembled data.

According to an embodiment, the SPR data analysis application 801 may include a global data mining module 848 configured to interface with the Internet. The module may optionally publish data from local experiments, e.g., a report generated by the kinetic table display module 846, and/or receive data from remote experiments.

The data analysis module software 801 may be used to display and analyze experimental data and video (.avi) files that result from conducting proteomic experiments using the SPR test apparatus 101, 201. The data analysis module may be used, for example, by chemists in laboratory environments focusing on antibody drug discovery. Such activities involve the relative ranking of affinities and investigation of the dynamics of surface plasmon resonance (SPR) binding interactions for a large number of antibody samples.

Typically, the Data Analysis Module 801 may be installed on a separate computer from the computer 302 used to run the SPR system 301. This may be recommended since users of the SPR apparatus control software 601 and the Data Analysis Module 801 may typically perform independent functions. Moreover, installation of both software applications 601, 801 on a single computer may not result in the highest productivity from the system.

The data analysis module 801 enables the precise alignment and fit of spot collections mediated by segmented analytes, and the viewing of these collections on a sensorgram. Measured over time, association and dissociation rates as well as the maximum change in intensity can be used to calculate affinity and concentrations. The data analysis module 801 may also display tabular data of relevant kinetic and binding parameters across analyte series of interest to maximize data mining opportunities. Multiple sensorgram plots of different spot collections and analyte series is provided for comparison and inclusion in reports. Because the relative affinities of thousands of target biomolecules for multiple analytes may be calculated quickly, a faster, more cost-effective, and accelerated method for the discovery of new biomolecules such as antibodies and biomarkers is provided.

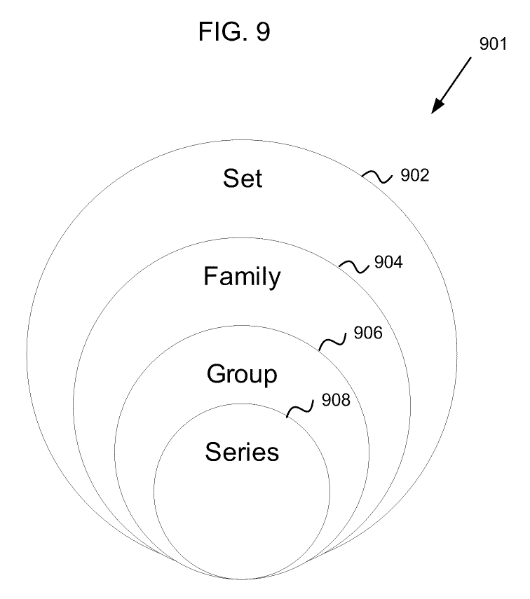

The data analysis module 801 gives users the option of organizing a collection of spots in the microarray 322 using hierarchical classes. A user may define a plurality, for example up to four, arbitrary classifications of spots within a microarray 322. A given spot may be a member of a set, family, group, and series. The hierarchy 901 is organized with subsets as illustrated in FIG. 9.

A spot set 902 is a collection of spots that are closely related in a user-defined way. For example, the spot set 902 may be likely to be plotted together for analysis at the end of an experiment. For example, several spots of the same protein, printed at different concentrations, may comprise a set 902. Alternatively, a set 902 may be a collection of peptides that are similar, for example having single amino acid substitutions at a particular amino acid in the sequence. The spots that make up a set 902 do not have to be located contiguously on the microarray 322, and may be located anywhere within the printable area.

Spots may be organized further as families 904 that are members of a set 902. Families 904 are also collections of spots that are closely related in another user-defined way. A set 902 may be made up of zero, one, or many families 904. In turn, a family 904 may be comprised of zero, one, or many groups 906, and each group 906 may be comprised of zero, one, or many series 908. The spots that make up a family 904, group 906, or series 908 do not have to be located contiguously on the microarray 322 and may, for example, be located anywhere within the printable area.

According to an example, a researcher has a library of antibodies she wants to array. To track how the proteins are spotted and facilitate the data analysis, the researcher may categorize the collection based on the nature of the antibodies and how they are treated experimentally. For example, the array could be organized as follows:
Set—Each antibody may be printed on the microarray 322 at five different concentrations to make a set 902.
Family—Each set 902 of antibodies directed against a particular kinase (abl, src, PKC, and so forth) may make a family 904.
Group—Each family 904 of antibodies directed against a type of kinase (e.g., tyrosine kinase Group, serine kinase Group, etc) may make a group 906.
Series—Each group 906 of kinases found to be related to a particular disease or tissue may form a series 908.

Alternatively, another researcher may choose to organize a microarray 322 based on how the samples were expressed, purified, prepared for spotting (e.g., types of buffers), printed (e.g., printer settings), etc.

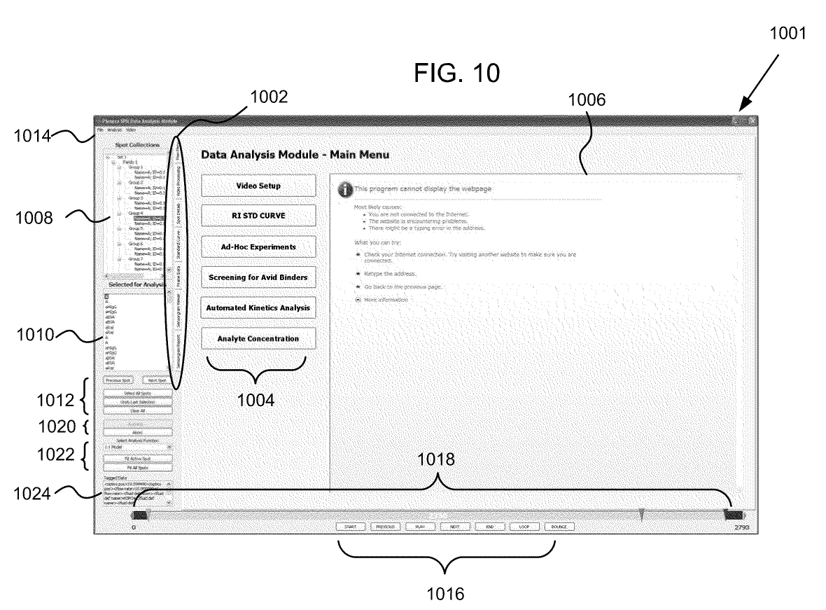

FIG. 10 is a screen shot of the main menu 1001 for the data analysis application software 701, 801, according to an embodiment. The main menu organizes access to functions and data used by the data analysis software 701, 801. The main menu may be displayed by selecting the “Main Menu” tab (the top tab, according to the embodiment depicted in FIG. 10) in the screen selection tabs 1002. From the main menu 1001 a user may select frequently used functions using function buttons 1004. The main menu 1001 also includes a browser window 1006. The browser window 1006 may be used, for example, to display an intranet or Internet web page.

FIG. 10 also shows additional graphical user interface components that are available from the main menu 1001, as well as from additional screen selection tabs 1002. A spot collections directory 1008 provides access to established data analysis hierarchies, such as ROIs organized according to a hierarchy 901 shown in FIG. 9. The spot collections director 1008 offers a convenient graphical interface for selecting sets 902, families 904, groups 906, and series 908. Spot collections 1008 are established, organized, and presented to the user by a spot collection module of the data analysis application software 701, 801. A selected for analysis list 1010 provides user-defined or other (such as system provider or microarray supplier) names for the spots in the spot collections directory 1008. For example, the user-defined names may correspond to analytes for which ligands corresponding to the spots have specific or general affinity. The example of FIG. 10 shows several abbreviated protein names and a generic name A, each of which is replicated a plurality of times across the microarray. The highlighted selected for analysis name corresponds to the highlighted spot collection name. Spots selected in the spot collection directory 1008 and/or spot names in the selected for analysis list 1010 may be selected with a pointer device, and/or may alternatively be selected by spot selection navigation buttons 1012.

Another feature available from all tabs is a menu bar 1014. Menus may, for example, allow access to data files to be analyzed, data analysis options, video file or source selection, and help files. Video controls 1016 are used to control video file playback. The SPR analysis software application 701, 801 may be used separate from data collection. This separation may reflect the way experiments are typically run where data may be collected at one time and/or location, and the collected data subsequently analyzed at a different time and/or location. Alternatively, the data analysis software application 701, 801 may be run in real time with data collection. For real time applications at least some of the video controls 1016 may be replaced or augmented by SPR apparatus 101, 201 controls.

For separate operation, referring to FIG. 3, the SPR apparatus 101, 201 may output video data corresponding to one or more experimental runs to a computer 302 via a video interface from the camera 310. Optionally, additional data corresponding to the experimental run may be transmitted from the electronics module 208 to the computer 302 or may be available from user-selected variables in an SPR apparatus control software application 601. The apparatus control software application 601 or another video capture application running on the computer 302 may receive the video data from the SPR test apparatus 101, 201, and save the received video data in a video data file. For example, the video data file may include an audio video interleave (AVI) file, such as a file identified by a “.avi” file extension, or another video file format such as QuickTime, Matroska, Ogg, MP4, or other format. The apparatus control software application 601 may further associate another file containing additional data corresponding to an experimental run to a given video file, or may combine the additional data with the video file, such as by using a tagged data format, a data identifier format, an application identifier format, or as pixel encoded data superimposed over a video field of view or combined with the video field using steganography.

Referring to FIG. 10, the video controls 1016 may control playback of one or more video files. According to an embodiment, the video controls 1016 include buttons “start” to start a playback, “previous” to go to a previous file, “play” to play or resume playback, “next” to go to a next file, “end” to go to the end of a video file, “loop” to invoke a looping function for continuous playback, and “bounce” to invoke a bounce function to produce a reverse playback. A video location indicator and control 1018 is configured to graphically indicate a current location in a video playback. A green arrow at the left end of the ribbon display corresponds to the start of a video file and a red arrow at the right end of the ribbon display corresponds to the end of a video file. A frame number, or alternatively another start and stop location indicator, such as a number of minutes, seconds, or milliseconds, is shown below the left and right arrows. A blue arrow, shown near the right end of the video location indicator and control 1018 in FIG. 10, moves according to the currently displayed frame. The blue arrow may be dragged and dropped to locations between the start arrow and the end arrow. Dragging or highlighting the location (blue) arrow may, according to embodiments, display a frame number. Analysis controls 1020 include buttons configured to run or abort data analysis. Analysis option controls 1022 allow control of the analysis options including selection of a kinetics model, described more fully below. A tagged data window 1024 displays additional data corresponding to an experimental run received from the apparatus control software or the apparatus 101, 201 as described above. For example, the tagged data may include illuminator and detector angle, flow rate, temperature, date of experiment, time of experiment, and/or at least one fluid definition.

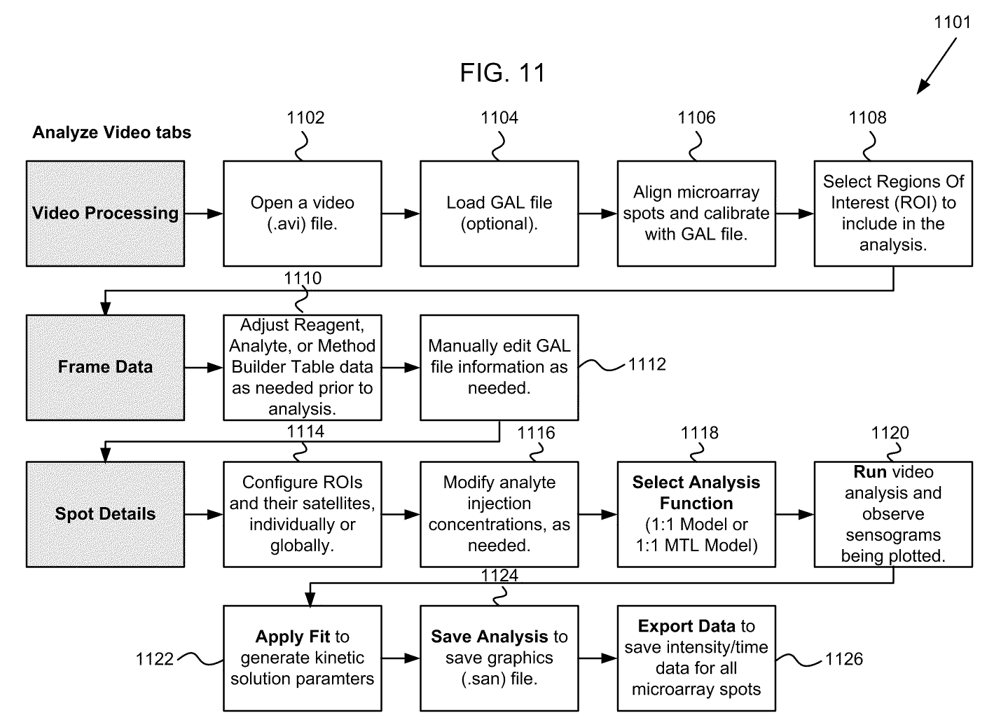

FIG. 11 is a flow chart showing workflow 1101 for analyzing data from an SPR experiment run on an SPR analysis system 101, 201 using data analysis application software 701, 801 according to an embodiment. Beginning with step 1102, a user opens a video file, for example using a File>Open command from the file menu, or by selecting an “Open Video” button on a video setup screen, shown below. As described above, the video file generally includes a video image of the SPR microarray 322 captured by the camera 310 as fluids are pumped through the flow cell 326, shown in FIG. 3. Proceeding to step 1104, the user may open a GAL file containing information corresponding to the regions of interest on the microarray 322.

Typically, a GenePix Array List (GAL) file may be loaded to provide definition for spots or regions of interest (ROI) that are on a given microarray. The GAL file is a text file that is generated by a microarray printer, the text file specifying the location, size, and name of each protein spot on the array. The header of each GAL file contains structural and positional information. Data records in each GAL file contain name and detailed identifier information from each spot. A GAL file may be selected, for example, from the file menu in the menu bar 1014. When a GAL file is selected, the spot collection directory 1008 and/or the selected for analysis list 1010 may be automatically populated. The GAL file may be loaded by accessing a File>Open command on the menu bar 1014, or optionally by selecting a “Load GAL File” button on a video setup screen shown below. Loading a GAL file is optional.

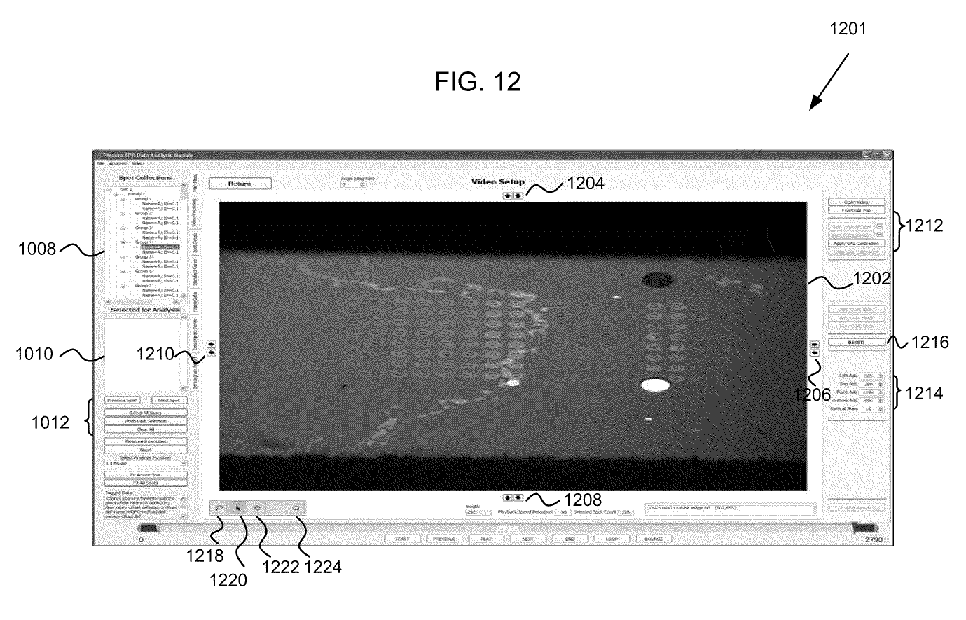

Proceeding to Step 1106, the microarray spots may be aligned to analysis software sensitivity regions. Optionally, the GAL file may be used to calibrate the image. FIG. 12 is a screenshot of the SPR data analysis application 701, 801 video setup screen 1201 with a video file opened, according to an embodiment. The video setup screen 1201 may be accessed by selecting a “Video Processing” tab located in the screen selection tabs 1002. The video image 1202 of a microarray is shown on the screen. The image 1202 of the microarray may be at least somewhat distorted. Referring to FIG. 3, the apparent vertical height of the microarray image may change as the incident and reflection angles θ and θ′ are changed. In particular, smaller angles θ and θ′ tend to reduce the apparent vertical size of the microarray video image 1202, and hence tend to squeeze the ROIs closer together. Conversely, larger angles θ and θ′ tend to increase the apparent vertical size of the microarray video image 1202 and tend to spread the ROIs farther apart. Skew, pincushion, barrel, rotation, and horizontal or vertical displacement may also tend to distort or otherwise change the microarray video image 1202.

The microarray spots are aligned by adjusting the image position buttons 1204, 1206, 1208, and 1210 arranged around the microarray video image 1202. This is done to align GAL overlays over the ROIs. The GAL overlays indicate the pixels or areas in the video image 1202 that will be used to track changes in surface plasmon resonance, the changes being expressed as changes in apparent reflectivity and, as described above, corresponding to an amount of analyte bound to a ligand printed on a given ROI. Adjusting the image position buttons 1204, 1206, 1208 and 1210 moves the GAL overlays relative to the microarray video image 1202. Generally, it is advisable to adjust the GAL overlays to be positioned near the center of each corresponding spot on the microarray. Adjustment of the GAL overlays may be used to drive an update of the GAL file to improve the accuracy of ROI position information included in the GAL file. This may be done dynamically, automatically, or responsive to a user selecting an “Apply GAL Calibration” button in a group of GAL alignment buttons 1212. Optionally, GAL overlays may be adjusted numerically using GAL overlay values in GAL overlay numeric input fields 1214. The numeric input fields 1214 may be expressed as pixel values.

Optionally, the data analysis software application 701, 801 may include image processing software configured to optimize the alignment between the ROIs and corresponding GAL overlays. Optionally, the data analysis software application 701, 801 may use angle θ and θ′ information in the GAL file to automatically align or partially align the GAL overlays to the ROIs.

For embodiments where a GAL file is not provided, for example, GAL overlays may be generated and a GAL file generated. To generate GAL overlays, or where existing GAL overlays are not very accurate to start with, the user may select buttons “Alight Top/Left Spot” and “Align Bottom/Right” in the GAL alignment buttons 1212. Intermediate GAL overlays may then be generated between the top left and bottom right ROIs in the image. A Reset button 1216 cancels GAL overlay alignment performed in the current session and restores starting positions of the GAL overlays.

Referring again to FIG. 11, the process next proceeds to step 1108, where a user or a program may select ROIs to be included in an analysis. According to an embodiment, ROIs may be selected for analysis by graphically selecting spots in the microarray video image. According to another embodiment, spots may be selected for analysis by selecting spots from the spot collections directory 1008, as described above. Selected spots then are listed in the selected for analysis table 1010. Alternatively, one may select all spots or select individual spots using the spot selection navigation buttons 1012.

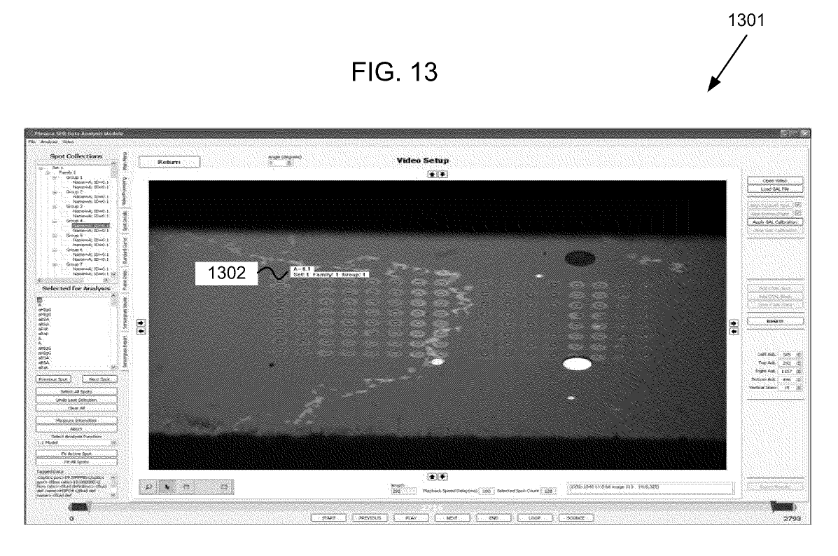

During spot selection, a selected spot may be highlighted and its identifying data given, as shown by spot 1302 in FIG. 13. The spot may be selected as described above, such as by selecting the spot in the microarray video image 1202, selecting the spot in the spot collections directory 1008, selecting the spot in the selected for analysis list 1010, and/or by selecting the spot using the spot selection navigation buttons 1012. In the example of FIG. 13, the spot identifying data 1302 includes the name (e.g. name of the ligand or the analyte for which the ligand has specificity), the concentration at which the spot was printed, and the heuristic grouping (e.g. set 902, family 904, group 906, and series 908 designators).

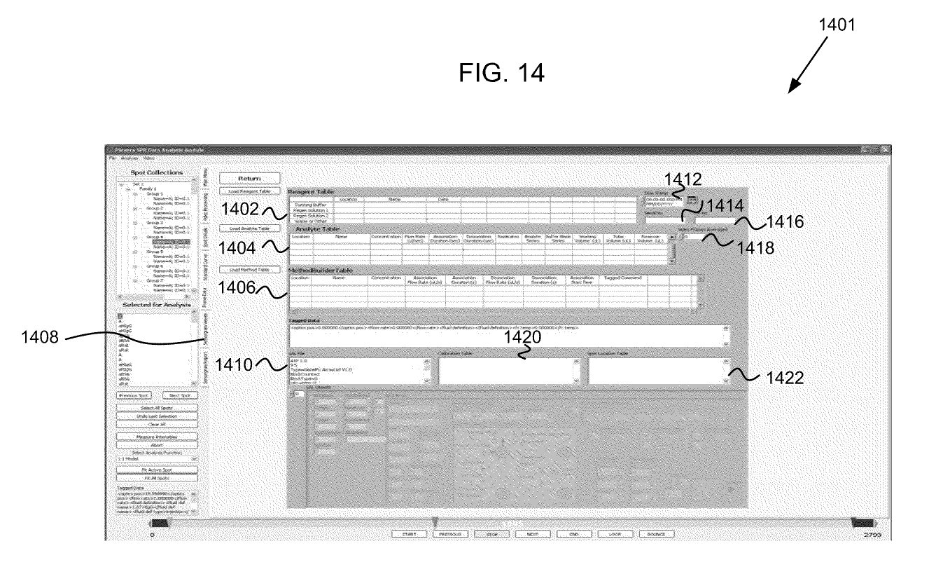

Referring again to FIG. 11, the process 1101 proceeds to optional step 1110, adjust table data. FIG. 14 is a screen shot of an SPR data analysis application frame data screen 1401, showing a reagent table 1402, analyte table 1404, and method builder table 1406, according to an embodiment. In step 1110, the user may click on the Frame Data tab 1408. The Frame Data 1401 dialog box is displayed. Data for the experiment to be analyzed is displayed in the analyte, reagent, and method builder tables 1404, 1402, 1406. As needed, the user may change any data in the reagent table 1402, analyte table 1404, and method builder table 1406 prior to analysis. For example, if a concentration was incorrectly entered during the original experiment, the user may correct the information.

Referring again to FIG. 11, the method proceeds to step 1112, where the user may manually edit GAL file information. The GAL file may be edited by entering information in a GAL file dialog box 1410, accessible on the SPR data analysis application frame data screen 1401 shown in FIG. 14. On the frame data screen 1401, the user may optionally also enter or update information in a time stamp field 1412, a serial number field 1414, and a lot number field 1416. The user may update video frames averaged in a video frames averaged field 1418. Video frame averaging may be useful for reducing processing time and/or for averaging noisy data. The user may also load and/or revise a calibration table in a calibration table field 1420 and load and/or revise a spot location table in a spot location table field 1422.

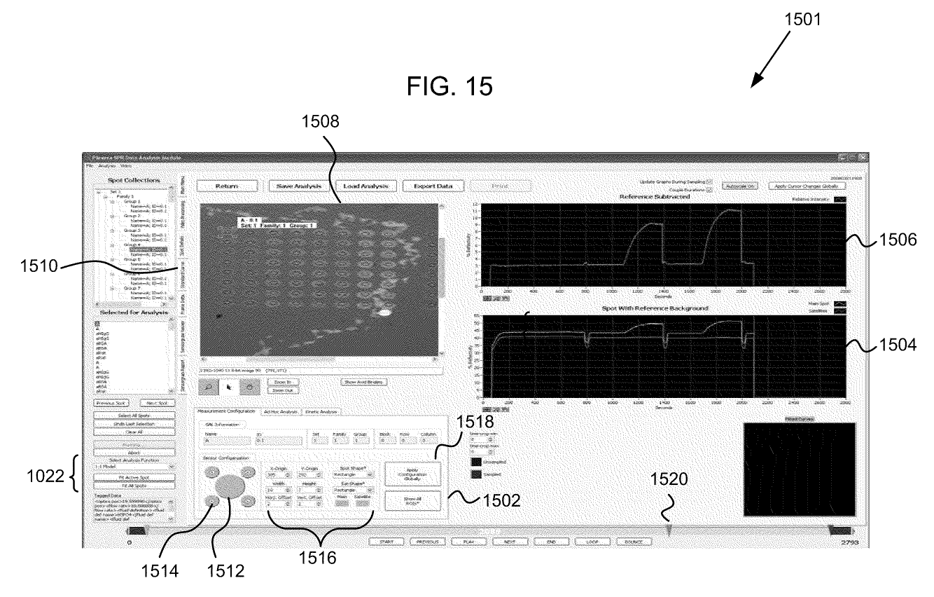

Referring again to FIG. 11, the process proceeds to step 1114, where the user or a software module may configure ROIs. FIG. 15 is a screen shot of an SPR data analysis application spot details screen 1501 illustrating a measurement configuration sub-tab 1502 and SPR response curve fields 1504, 1506 illustrating SPR responses for a spot shown in a video window 1508 from a partially played video file, according to an embodiment. The spot details screen 1501 may be accessed from the Spot Details tab 1510. In step 1114 of the process 1101, the user or a software module may configure measurement points on the video image.

The measurement details sub-tab 1502 includes a dialog box that includes a cartoon of the measurement area 1512 of selected ROI on the microarray and its satellites 1514. Using the Intensity Sensor Configuration tools in the dialog box 1502, the user may configure an ROI and its satellites. Such adjustment may be made by dragging and dropping the measurement indicators and/or by entering data in data entry boxes 1516. The ROI and satellite configuration may made to individual ROIs and/or may be applied to all ROIs via the “Apply Configuration Globally” button 1518. Parameters that may be customized with the measurement details tools include spot and satellite locations, spot and satellite sizes, and spot and satellite shapes. One or more spots and/or satellites may also be selected to be hidden (e.g., ignored). For example, if the microarray has a smear or a satellite or spot is in the path of a bubble, the data may be ignored to reduce any aliasing in the data.

Satellites are used for background subtraction. Background subtraction may be valuable to account for differences in image intensity that are not due to binding. The satellite measurements are generally taken in regions corresponding to a non-specific binding (NSB) resistant background surrounding the printed analyte. For example, if a sample containing an analyte is injected at a temperature different than the buffer solution, or if the bulk index of refraction of the sample is otherwise different than the buffer solution, then the SPR intensity may change substantially uniformly as the sample flows over the microarray. Such uniform changes may be observed in an unconfounded way by observing the response of the satellites. If the fluid contains an analyte that an ROI is selected to bind, then the intensity of the ROI will be affected both by the analyte binding and by the bulk change in refractive index. The SPR analysis software 701, 801 is configured to subtract changes in response of the satellites from the response of the ROI. This subtraction thus compensates for changes in SPR response not related to analyte binding.

As an alternative to manual editing of spots and satellites, the SPR analysis software 701, 801 may include an image analysis software module and/or other modules that automatically configure the measurement spot and its satellites, for example using considerations disclosed above.

Returning to FIG. 11, the process proceeds to step 1116, where analyte injection concentrations may be modified as needed. Proceeding to step 1118, the analysis function may be set using the analysis option controls 1022. For example, one of the analysis option controls selects a kinetics model (e.g., first order, 1:1, 1:1 MTL (mass transfer limited), second order, reactant inhibited, and/or product inhibited kinetics) and selection of spots for fitting to the kinetics model (e.g., active a particular spot or all spots).

Optionally, a kinetics modeling module may include automatic kinetics model selection and be configured to select a kinetics model to best fit SPR data. For example one or more sets of SPR data may be fit to each of a plurality of kinetics models. The fitting to a plurality of kinetics models may, for example, be computed using a corresponding plurality of regression analyses. The kinetics model providing the best fit to the data, optionally including one or more additional constraints, may then be nominated as the proper kinetics model. Additional curve-fitting and regression analysis of corresponding to additional experimental runs of the association and dissociation reactions may be used to prove or disprove the nominated kinetics model. Alternatively, the nominated kinetics model may be accepted as the proper kinetics model without additional experimental data.

Proceeding to step 1120, a video analysis may be run. Returning to FIG. 15, association and dissociation curves for a spot and background (satellites) are shown plotted in the spot with reference background window 1504 at a time corresponding to the position of the video position pointer 1520. The curves in window 1504 show a series of dips in both the spot and the background corresponding to bubbles injected by the fluidics system to separate and reduce cross-contamination of injection samples. Association and dissociation curves may be seen for the spot with substantially no change in the corresponding background. During the association portion of the curves, a fluid containing the analyte is passed over the spot, with spot loading increasing progressively during the exposure. At a time after injection of the analyte, a buffer is flowed over the spot, resulting in dissociation.

The “reference subtracted” window 1506 shows the association and dissociation curves with the satellite values subtracted from the spot value. The scale is also expanded because the reference subtraction removed the steep increase in reflectivity at the beginning of the run corresponding to system start-up (and light source warm-up). The scale of both plot windows is selected automatically by a plotting module of the software to maximize sensitivity while keeping the curves within range. The dissociation of the analyte is somewhat easier to see in the “reference subtracted” window 1506. The two association/dissociation curves result in different responses because the analyte was at a higher concentration in the second injection.

Returning to FIG. 11, the process proceeds to step 1122 where the selected kinetics model (or as described above a series of kinetics models) is best fit to the data. The best fit results in determining kinetics parameters. Proceeding to step 1124, the analysis is saved including, optionally, saving the graphic images of the association and dissociation curves. Proceeding to step 1126, the data is exported to an output file or to another program.

Returning to FIG. 10, a number of tasks may be accessed using the function buttons 1004. A refractive index (RI) standard curve module accessible from the main menu 1001 may be run about every two months. The RI standard curve calibrates the data analysis application software 701, 801 to data captured and output by the SPR analysis apparatus 101, 201. Ad-hoc experiments may include experiments that do not include corresponding GAL files, and/or which use only portions of the processes described herein. Screening for avid binders may be performed to screen for analytes in an unknown sample. For example, an unknown fluid may be flowed over a microarray including potentially a large number of different ligands. The SPR data analysis software may monitor the results and nominate particular responses as being indicative of a high affinity between ligand and analyte. Avid binder screening may be particularly useful for drug screening work.

Generally, the SPR data analysis program described herein provides a graphical user interface to a plurality of software modules configured to receive SPR data from an SPR analysis apparatus 101, 201 and generate kinetics modeling, ad-hoc experimental output, screening for avid binders, and/or other functions. Optionally, one or more of the above-described functions may be run automatically and substantially without user intervention. Accordingly, the user-initiated or user-mediated steps described above also describe software-initiated or software-mediated steps.

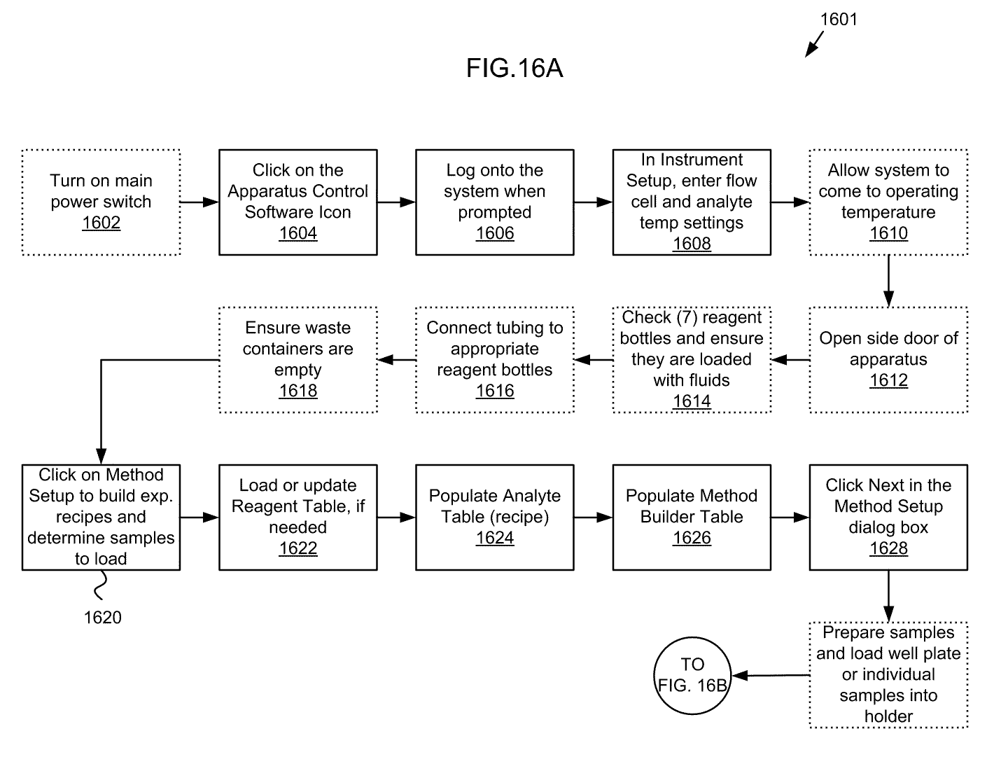

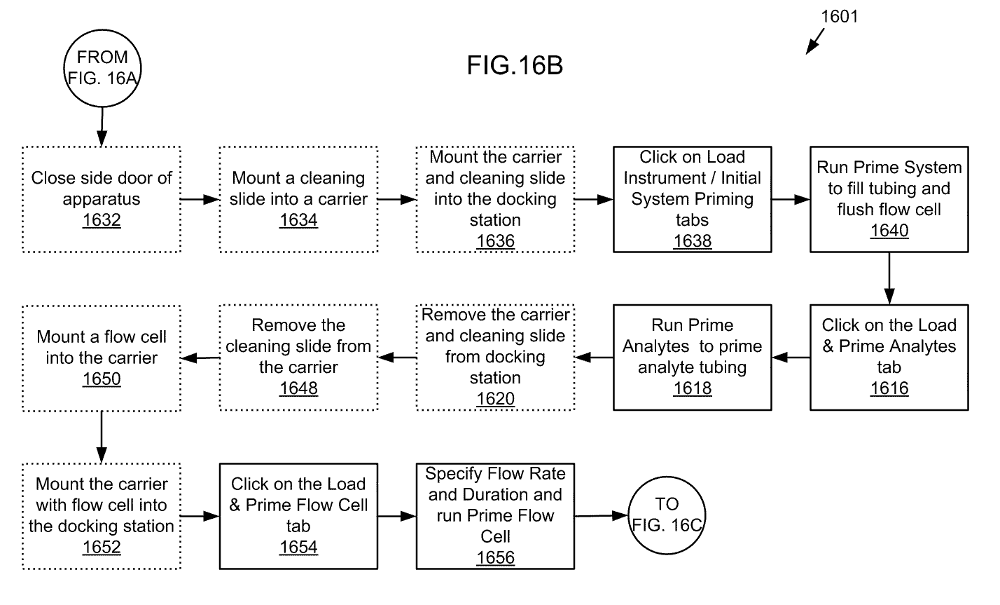

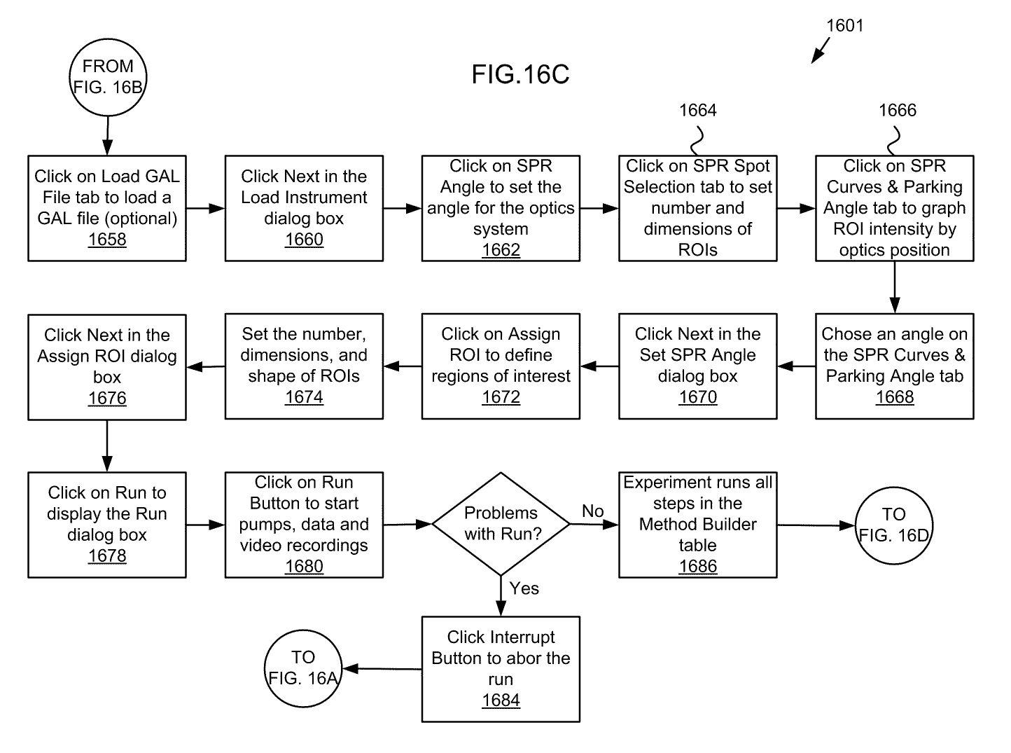

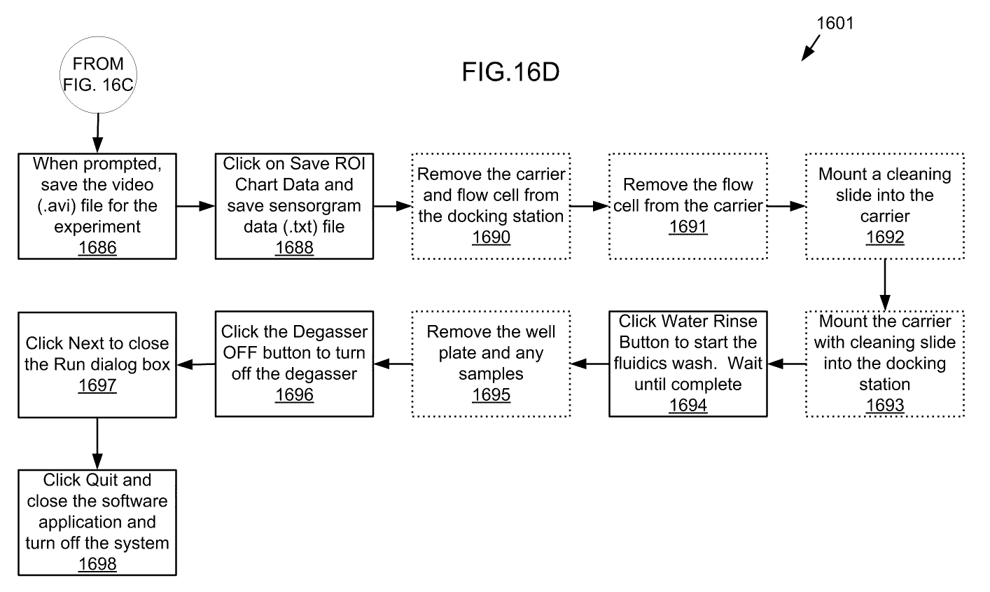

FIG. 16A is a flow chart indicating work flow for using an SPR analysis apparatus 101, 201, including control of the apparatus from an SPR apparatus control application software running on a computer system 302 shown in FIG. 3, and represented by the module diagram 601 of FIG. 6, according to an embodiment. The flowchart of FIG. 16A; which is continued in FIGS. 16B, 16C, and 16D; includes both apparatus actions; i.e. physical actions where a user interacts with the SPR analysis apparatus 101, 201; and software actions, wherein a user interacts with the apparatus control software 601. Software actions are indicated by solid boxes. Apparatus actions are indicated by dashed boxes. In step 1602, the user turns on the main power switch on the SPR analysis apparatus 101, 201. In steps 1604 and 1606, the user respectively starts and logs into the apparatus control software application. Proceeding to step 1608, the user enters an apparatus setup screen in the apparatus control software application.

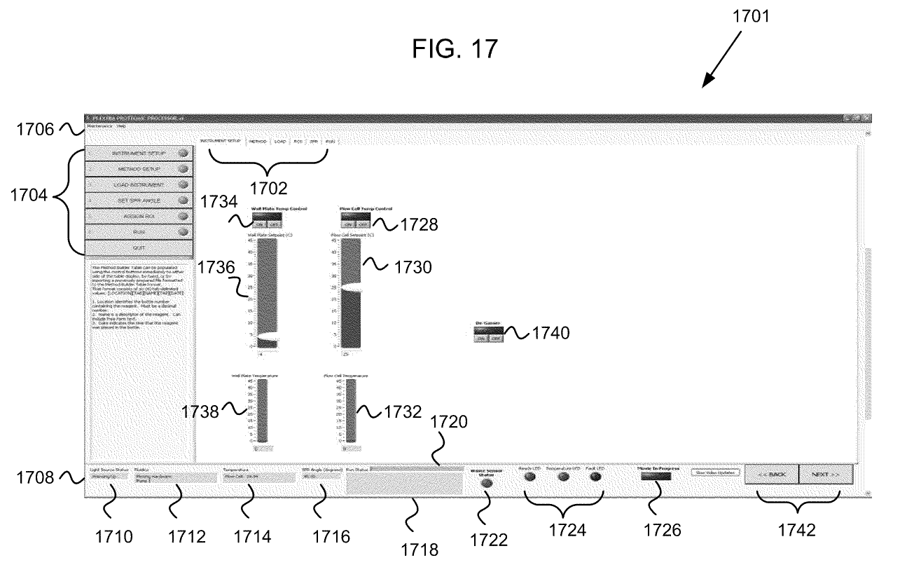

FIG. 17 is a screen shot of an apparatus setup screen 1701 of the apparatus control application software 601, according to an embodiment. The apparatus setup screen 1701 may be displayed by selecting the apparatus setup tab in the screen selection tabs 1702. Next to the apparatus setup portion of the screen are function buttons 1704 by which a user may select frequently used functions. A menu bar 1706 provides access to other functions. An apparatus status dashboard 1708 provides a ready display of apparatus 101, 201 status information. According to an embodiment, the apparatus status dashboard 1708 includes indicators for light source status 1710, fluidics status 1712, and temperature 1714. The temperature status indicator 1714 may provide temperature information for one or more of the flow cell and/or other temperature measurement locations. An SPR angle indicator 1716 provides the current value for the incident and reflection angle θ and θ′, as illustrated in FIG. 3. A message field 1718 may provide relatively verbose feedback to the user. A run status field 1720 may show the status of the current experimental run. A waste sensor status indicator 1722 “illuminates” when the waste collection bottle reaches the level of a level sensor. Status indicators 1724 mimic physical LED indicators on the front panel of the SPR analysis apparatus 101, 201. A movie in progress indicator 1726 provides an indication that video is being received from the camera 310 indicated diagrammatically in FIG. 3.

Within the apparatus setup dialog box 1701, a degasser control 1740 may be used to turn the fluidics module degasser on or off. A flow cell temperature control 1728 may be selected to turn flow cell temperature control on or off. A flow cell temperature set point control 1730 may be adjusted to a desired flow cell temperature, and a flow cell temperature indicator 1732 is configured to display the actual temperature of the flow cell or tubing leading to the flow cell. Similarly a well plate temperature control 1734, well plate temperature set point control 1736 and well plate temperature indicator 1738 indicates the actual temperature of the autosampler well plate.

“Next” and “back” buttons 1742 may be used by a user to be automatically guided through the setup and/or apparatus run process, according to an embodiment. Pressing the “next” button advances the screen to the next screen where interaction with the apparatus control application 601 is indicated in the workflow flowchart of FIGS. 16A-16D. Pressing the “back” button returns to the previous screen. In this way, the apparatus control software application 601 is configured to navigate a user through the process. It will be understood that pressing the “next” and/or “back” buttons 1742 may be used to access screens described herein. Alternatively, the screens may be accessed by selecting tables 1702, function buttons 1704, and/or by other navigation controls included in the screens. Typically, one or more of these alternative navigation approaches is described below, generally in lieu of redundant reference to the “next” and “back” buttons 1742.

Referring again to FIG. 16A, in step 1608, the user (or optionally a computer program) activates the flow cell temperature control 1728 and enters the desired flow cell temperature set point control 1730. Similarly, the user may activate the autosampler well plate temperature control 1734 and enter the desired well plate temperature with the well plate temperature set point control 1736. Proceeding to step 1610, the system is allowed to come to operating temperatures, which may be monitored on the temperature indicators 1732, 1738.

Proceeding to steps 1612 and 1614, the user accesses the fluid supply volume 104 and checks the reagent bottles 206 (visible in FIGS. 1 and 2) to make sure they have sufficient amounts of reagent. In step 1616, the user may connect supply tubing to any replacement reagent bottles 206. In step 1618, the user may check to see that the waste container bottle 212 (visible in FIG. 2B) and the autosampler waste container as sufficient empty volume to run an experiment. For example, this may include making sure both waste containers are empty. Steps 1612 through 1618 (and later steps up to when an experiment is to be run) may occur simultaneously with step 1610.

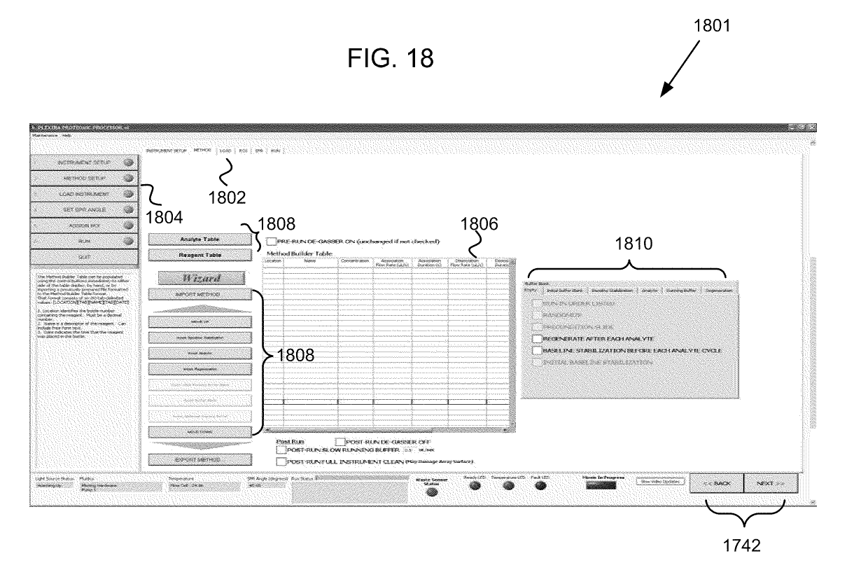

Proceeding to step 1620, the user may build experiment recipes and determine what samples to load into the SPR analysis apparatus 101, 102. FIG. 18 is a screen shot of a method setup screen 1801 of the apparatus control software program 601, according to an embodiment. The method setup screen 1801 may be accessed by selecting the method tab 1802 from the screen selection tabs 1702 or from the method setup button 1804 in the function buttons 1704. Each of several data tables 1806 may be accessed by selecting a corresponding table selection button 1808 (or via the “next” or “back” button 1742). Referring again to FIG. 16A, the user (or a program) may load or update a reagent table 1806 in step 1622, populate an analyte table 1806 in step 1624, and populate a method builder table 1806 in step 1626. The reagent table is used to indicate the properties of reagents 206 that are pumped through the flow cell 326. The analyte table is used to indicate information about the analyte solutions that are pumped through the flow cell 326, typically from the autosampler 204. The method builder table 1806 (shown) is used to specify the sequence of events that take place during an experiment run or during a sequence of experiment runs.

For example, referring to step 1626 of FIG. 16A, the method builder table may be populated using control buttons 1808 on the left side of the table display 1806 and tabbed control buttons 1810 on the right side of the table display 1806. Alternatively, values may be entered into the table by typing, or by importing a previously prepared file formatted according to the method builder table format. The method builder table format defines a record according to tab-delimited values. For example, according to one embodiment, the tab-delimited values for a given record may include: [location][tab][name][tab][concentration][tab][association flow rate][tab][association duration][tab][dissociation flow rate][tab][dissociation duration][tab] [date] [return].

According to an example, “location” identifies a decimal bottle number containing a reagent. “Name” is a free-form alphanumeric description of the reagent. “Concentration” is a concentration of the reagent. “Association flow rate” is the flow rate of the fluid in a microliters/second decimal value at which the reagent is pumped through the flow cell during an association phase. “Association duration” is the length of time in decimal seconds during which the reagent is pumped through the flow cell during the association phase. “Dissociation flow rate” is the flow rate of the fluid in a microliters/second decimal value at which the reagent is pumped through the flow cell during a dissociation phase. “Dissociation duration” is the length of time in decimal seconds during which the reagent is pumped through the flow cell during the dissociation phase. “Date” is the date the reagent was put in the reagent bottle. In step 1628 the user may navigate to the next screen by pressing the next button 1742, or the user may alternatively navigate using other controls. Proceeding to step 1630, the user prepares and loads analyte fluids, for example by loading an autosampler 204 well plate or by loading individual samples into a sample holder. The samples loaded correspond to the analyte data entered in the analyte table in step 1624.

FIG. 16B is a second portion of the flow chart of FIG. 16A, according to an embodiment. After step 1630, the process proceeds to step 1632, wherein the user closes the access doors to the fluid supply volume 104 (FIG. 1). Proceeding to step 1634, the user mounts a cleaning slide (flow cell) into a slide carrier. A cleaning slide is typically a blank or used microarray flow cell that is used to flow fluids through the SPR analysis apparatus 101, 201 prior to and after actual test runs. The cleaning slide 326 is loaded into the carrier 510 as illustrated in FIG. 5B. The flow cell 326 typically sits in the carrier 510 relatively tightly, but without binding. Proceeding to step 1636, the carrier 510 carrying the cleaning slide 326 are mounted into the docking station or body 502 using the flow cell mounting assembly 508.

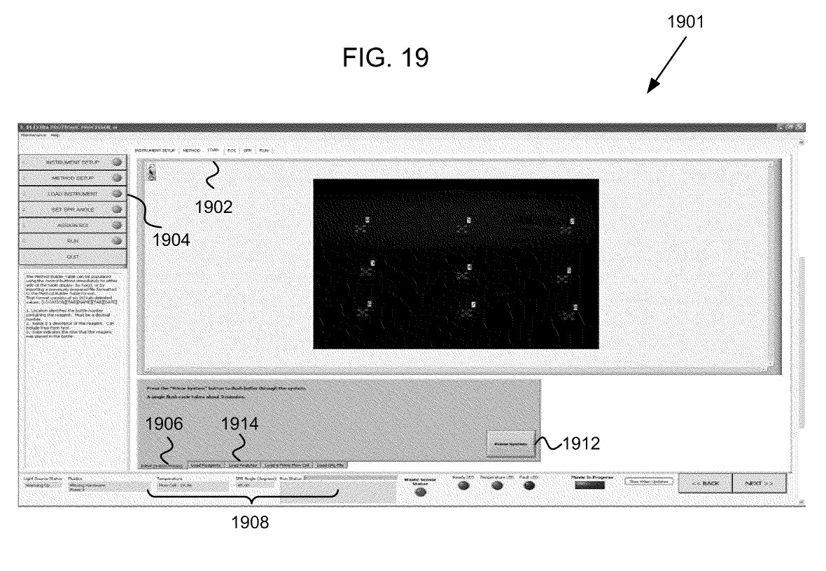

Proceeding to step 1638 of FIG. 16B, the user navigates to the “load instrument”/“initial system priming” screen 1901, shown in FIG. 19. Screen 1901 may be accessed by selecting the load tab 1902 from the screen selection tabs 1702 or from the load setup button 1904 in the function buttons 1704, followed by selecting the “initial system priming” tab 1906 in the load sub-tabs 1908.

Each of the “Load,” “Assign ROI,” and “Run” screens (some described below) feature a live video feed 1910 of a portion of the microarray. Since the response of at least some ROIs on the microarray may be visible to the human eye in the video image 1910 (which may be wavelength-shifted compared to the actual microarray illumination wavelength), monitoring the video image 1910 may provide the user with real-time feedback that association and/or dissociation is occurring as expected. The portion of the microarray included in the video image 1910 is generally selectable by the user and/or by software. For example, the video image 1910 may include a three-by-three or four-by-three array of ROIs. Selection of a subset of the entire microarray may help to make the apparent size of the individual ROIs large enough to be seen by the user. The subset of the microarray displayed in the video image 1910 may be selected to include one or more particular ROIs that are expected to respond with a change in reflectance during a given experimental run. The array of ROIs may be selected to be actual neighboring ROIs. Alternatively, the video image 1910 may be constructed from ROIs located at disparate, non-neighboring locations across the microarray, and assembled in the video image 1910 as tiles. The inclusion of the video image 1910 in the references screens was found to generate positive user feedback, such users generally being appreciative of having some live image by which they can monitor their experiments.

The “prime system” button 1912 is selected in step 1640. Responsive to receiving a prime system command, a prime module the apparatus control software 601 commands one or more of the pumps in the fluidics module 210 to fill tubing to the flow cell 326 and the flow cell 326 itself and flush the tubing and flow cell 326 with running buffer solution. Proceeding to step 1642, the user navigates to the “load and prime analytes” screen by selecting the sub-tab “load analytes” 1914 to reach a screen that looks similar to screen 1901 of FIG. 19. Proceeding to step 1644, the user again selects the Prime button 1912. Responsive to receiving a command from the prime button 1912 in the load analytes screen, the prime module of the apparatus control software pumps a buffer solution through the analyte tubing such as the tubing and/or needle in the autosampler 204. After the priming is complete, the process proceeds to steps 1646 and 1648. Referring to FIGS. 5A and 5B, the user removes the carrier 510 from the body 502 using the carrier release mechanism 510, and removes the cleaning slide (flow cell) 326 from the carrier 510. According to step 1650, the user then loads a flow cell 326 including a desired (printed) microarray 322 into the carrier 510, reloads the carrier 510 into the body 502, according to step 1652, and closes the body 502 against the prism 320.

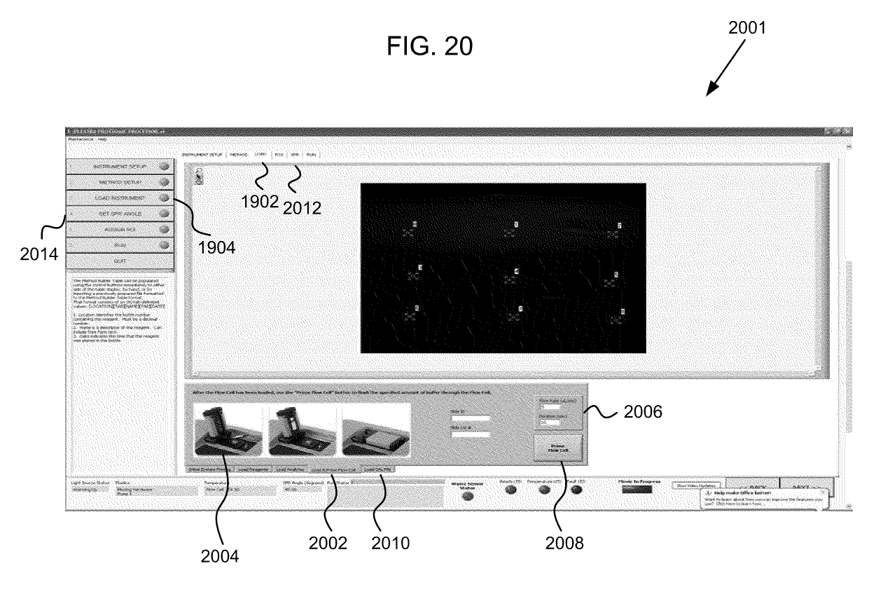

The process of FIG. 16B the proceeds to step 1654. In step 1654, the user navigates to the “Load”/“Prime Flow Cell” screen. FIG. 20 is a screen shot of the load/prime flow cell screen 2001 of the apparatus control software program 601, according to an embodiment. Screen 2001 may be accessed by selecting the load tab 1902 from the screen selection tabs 1702 or from the load setup button 1904 in the function buttons 1704, followed by selecting the “Load & Prime Flow Cell” tab 2002 in the load sub-tabs 1908. The load & prime flow cell tab 2002 may display graphical directions 2004 for interacting with the SPR analysis apparatus 101, 201 during the corresponding workflow step 1654.

Similarly, according to embodiments, instructions such as graphical instructions, written instructions, and/or video instructions may be provided on other apparatus control software 601 screens. The SPR apparatus control software 601 may thus provide self-contained training for use of the SPR analysis apparatus 101, 201 to a novice or experienced user.

Proceeding to step 1656, the user may accept default values or may enter flow rate and duration in the flow rate and duration controls 2006.

FIG. 16C is a third portion of the flow chart of FIGS. 16A and 16B, according to an embodiment. Proceeding to optional step 1658, the user may access the “load GAL file” sub-tab by selecting the load GAL file sub-tab 2010, shown in FIG. 20. The user may select a GAL file corresponding to the mounted microarray by selecting an “Import GAL” button (not shown) on the load GAL file sub-tab 2010. Proceeding to steps 1660 and 1662, the user may access the set SPR angle screen.

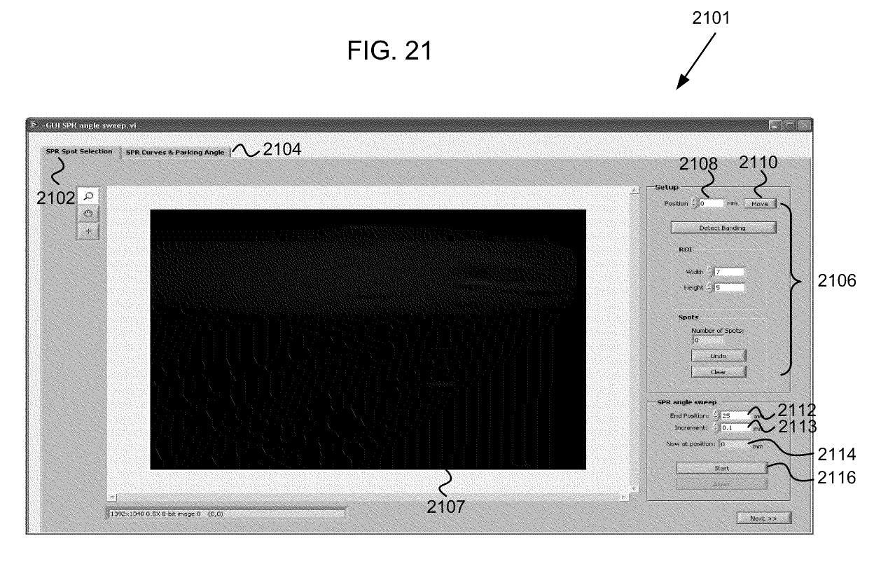

Proceeding to step 1664 of FIG. 16C, the user next enters the spot selection screen 2101 of FIG. 21 by selecting the ROI tab 2102 from the screen selection tabs 1702 or from the assign ROI button 2104 in the function buttons 1704. The set SPR angle screen 2101 includes two tabs, SPR Spot Selection 2102 and SPR Curves & Parking Angle 2104. In the SPR spot selection tab 2101, the position of optical ROIs may be selected by clicking in the video image 2107 of the microarray. Typically, a user may select five to ten (or a maximum of 25) optical ROIs that uniformly cover the slide-viewing area. They selected areas may (and should) represent printed spots and points in the background. In the setup area 2106 of the SPR spot selection tab 2102, the user may select a number and dimensions of optical ROIs that will be used to select an SPR angle. In the setup area 2106, the user may set the width and height for the ROIs. The user may locate a high-contrast optics angle by entering a position (in millimeters) in the position box 2108, and clicking the move button 2110 to adjust to the specified angle. The position entered in the position box 2108 must be less than the end position 2112 defined in the SPR angle sweep area 2114.

The user sets the SPR angle sweep by entering the end position (in millimeters) 2112 for the optics angle and movement increment (in tenths of a millimeter) 2113. A smaller increment may provide greater accuracy. The user then clicks the start button 2116. The optics position will move from 0 to the end position 2113, followed by a brightening of the image region 2107.

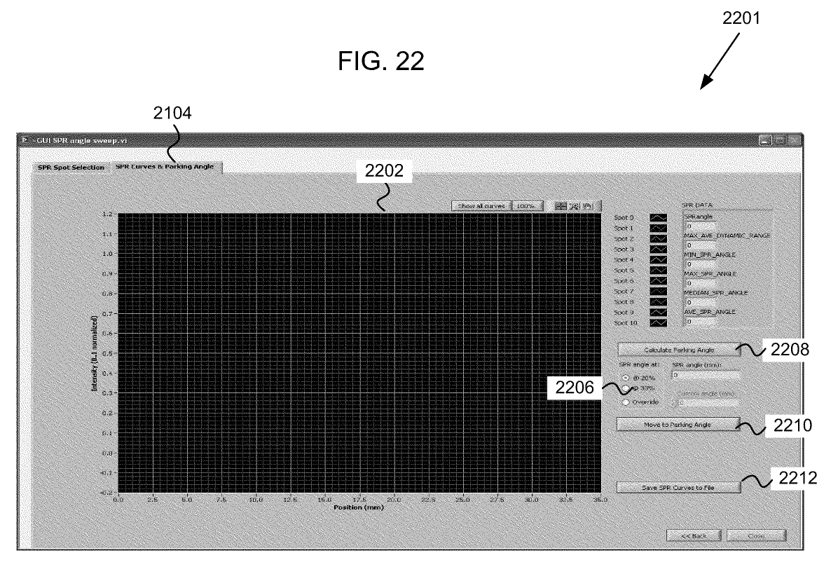

Proceeding to step 1666, the user may select the SPR curves & parking angle tab 2104. FIG. 22 is a screenshot of the SPR curves & parking angle screen 2201, according to an embodiment. The SPR Curves & Parking Angle tab 2104 includes a displayed graph 2202 of the normalized intensity of ROIs by optics angles. A message box displays when the scan is complete. Proceeding to step 1668, the user may then select an SPR angle using the SPR angle controls 2206. Typically, a user should choose an angle within about 20% to 30% of the linear range minimum. If the user wishes to follow this guidance, then the user may click calculate parking angle button 2208, and then the move to parking angle button 2210. Optionally, the user may select an override radio button in the SPR angle controls 2206 and enter an angle of his or her choice in a custom angle data field. If a user wants to save the SPR curves and parking angle information, he or she may click on the save SPR curves to file button 2212.

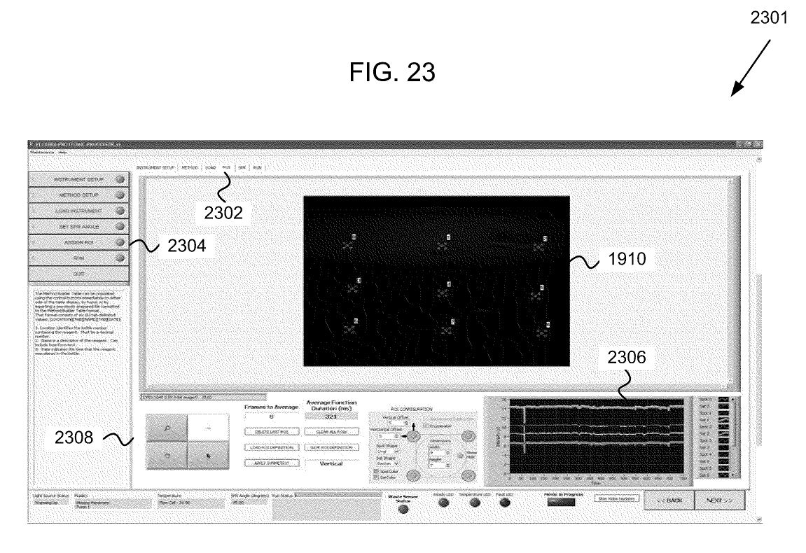

Proceeding to step 1672, the user accesses the assign ROI screen 2301, shown in FIG. 23, where the user may assign regions of interest (ROIs). The assign ROI screen 2301 may be accessed by selecting the ROI tab 2302 from the screen selection tabs 1702 or from the assign ROI button 2304 in the function buttons 1704. The video image 1910 shows a selected region of the microarray. A real-time sensorgram 2306 is displayed in the ROI setup image area 2308, showing default ROI parameters. Proceeding to step 1674, real time ROI parameters may be selected as described above, in conjunction with FIG. 15.

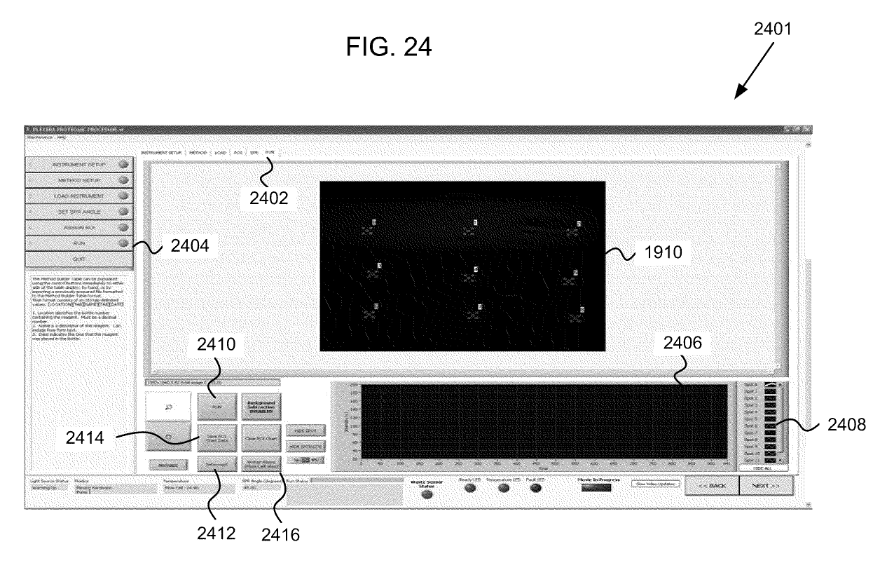

Proceeding to steps 1676 and 1678, the user is ready to run an experiment. FIG. 24 is a screenshot of a run screen 2401 of the apparatus control software program 601, according to an embodiment. The run screen 2401 may be accessed by selecting the run tab 2402 from the screen selection tabs 1702 or from the run button 2404 in the function buttons 1704. The run screen 2401 includes a live video image of a portion of the microarray 1910 and also a live sensorgram graph 2406 configured to plot the selected ROIs listed in the ROI list 2408. Proceeding to step 1680, the user clicks the run button 2410. Clicking the run button causes a run module of the apparatus control software 601 to execute a sequence of commands to the electronics module 208, shown in FIG. 3.

Proceeding to step 1682, if a user sees a problem with a run, the user may press the interrupt process to stop the experimental run. The user may repeat any and/or all of the steps 1602 through 1680.

Proceeding to step 1686, if there is no abort or interrupt command received by the SPR apparatus control program 601, a run module of the program 601 sequences through a series of commands to the SPR analysis apparatus 101, 201 configured to drive a sequence of pump and valve actuations in the fluidics module to run the reagents and analytes defined in the method setup screen 1801 of FIG. 18 according to the flow rates and durations defined in the method builder table 1806. As the fluids are pumped over the microarray, the camera 310 delivers a video image to a video capture module of the apparatus control software program 601, according to an embodiment. The video capture module creates a video file, which is a record of the response of the ROIs to the analytes and reagents.

FIG. 16D is a fourth portion of the flow chart of FIGS. 16A, 16B, and 16C, according to an embodiment. Proceeding to step 1686, the run module prompts the user to save the video file. To save the video file in step 1688, the user clicks the save ROI chart data button 2414.

Proceeding to steps 1690, 1691, 1692, and 1693, and in reference to FIGS. 5A and 5B, the user removes the carrier 510 from the body 502 using the carrier release mechanism 510, and removes the flow cell 326 from the carrier 510. The user then loads a cleaning slide 326 into the carrier 510, and reloads the carrier 510 into the body 502, and closes the body 502 against the prism 320. Proceeding to step 1694, the user then clicks the water rinse button 2416 on the run screen 2401 (FIG. 24). Proceeding to step 1695, the user removes the autosampler 204 well plate and/or any other sample containers. Proceeding to step 1696, the user accesses apparatus setup screen 1701 (FIG. 17) and turns off the degasser using the degasser controls 1714. It is advisable to turn off the degasser when not taking experimental data because degassers typically have limited service lives. Proceeding to steps 1697 and 1698, the user exits the apparatus control software program 601 and turns off the SPR analysis apparatus 101, 201.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

1. An SPR analysis system, comprising:
a computer system configured to run an apparatus control application having a graphical user interface; and
an SPR analysis apparatus operatively coupled to the computer system, including:
an electronics module including control circuitry coupled to receive control data from the computer system and responsively control an autosampler, a fluidics module, and an optics module.

2. A computer readable medium carrying computer readable instructions for running on a computer system operably coupled to an SPR analysis apparatus, the computer readable instructions comprising an apparatus control application including:
a graphical user interface module for receiving user commands for controlling the SPR analysis apparatus; and
an apparatus control module configured to receive user commands from the graphical user interface module and operable to transmit corresponding commands to an electronics module of the SPR analysis apparatus;
wherein the apparatus control module includes at least one temperature control module, at least one motion control module, at least one camera control module, at least one fluidics control module, and at least one light source control module, each configured to generate commands for corresponding portions of the SPR analysis apparatus responsive to user commands received from the graphical user interface module.

3. The computer readable medium of claim 2, wherein the apparatus control application further comprises a communications interface to an SPR data analysis application.

4. A computer readable medium carrying computer readable instructions for running on a computer system operatively coupled to an SPR analysis apparatus, the computer readable instructions comprising a data analysis application including:
a graphical user interface module for receiving user commands for analyzing data from an SPR analysis apparatus; and
an SPR database module configured to receive queries and store data from the graphical user interface module and configured to respond to the queries from graphical user interface module;
wherein the SPR database module includes at least one data storage table, at least one kinetics formulae module, at least one fluidics recipe module configured to store fluidics operating parameters for driving a fluidics module of the SPR analysis apparatus, and at least one relationship diagram module.

5. The computer readable medium of claim 4, wherein the data analysis application further includes a communications interface to an apparatus control application.

6. The computer readable medium of claim 4, further comprising:
a main screen display module configured to display a video SPR image of a microarray and a sensorgram configured to display response data from a plurality of regions of interest corresponding to the video SPR image.

7. The computer readable medium of claim 4, further comprising:
a global data mining module configured to interface with the Internet wherein a remote user may access local data and a local user may access remote data.

8. The computer readable medium of claim 4, further comprising:
a communications interface to an SPR apparatus control application.

9. The computer readable medium of claim 4, wherein the graphical user interface module further comprises:
a video and sensorgram display module configured to display at least a portion of a video SPR image and a sensorgram configured to display response data from one or more of a plurality of regions of interest corresponding to the video SPR image.

10. The computer readable medium of claim 9, wherein the video and sensorgram display module is further configured to receive selection of one or more of the plurality of regions of interest.

11. The computer readable medium of claim 9, further comprising a layout grid display module configured to adjust locations of regions of interest in the video SPR image responsive to changes in SPR angle.

12. The computer readable medium of claim 9, further comprising a kinetic analysis module configured to determine at least one of association constant, dissociation constant, or equilibrium constant corresponding to binding of an analyte to the plurality of regions of interest.

13. The SPR analysis system of claim 1, wherein the apparatus control application comprises:
a software module configured to receive at least one of analyte or flow cell temperature settings, and display at least one temperature corresponding to the analyte or flow cell; and
a communications module configured to transmit commands corresponding to the temperature settings to the electronics module, and receive data from the electronics module corresponding to at least one measured temperature corresponding to at least one of the analyte or flow cell.

14. The SPR analysis system of claim 1, wherein the apparatus control application comprises:
a method setup module configured to receive experiment recipes including sequences and timing for a plurality of analyte association and dissociation phases.

15. The SPR analysis system of claim 1, wherein the apparatus control application comprises:
a module configured to load a GenePix Array List file corresponding to a microarray loaded in the SPR analysis apparatus.

16. The SPR analysis system of claim 1, wherein the apparatus control application comprises:
a live video display window module configured to display a live video image corresponding to a microarray loaded in the SPR analysis apparatus; and
a video record module configured to receive and store the live video image displayed in the live video display window.

17. The SPR analysis system of claim 16, wherein the live video display window module is further configured to receive selection of regions of interest in the live video display window; and further comprising:
a sensorgram display module configured to display a live sensorgram corresponding to a plurality of the selected regions of interest as a sample is injected through a flow cell in operative communication with the microarray.

18. The SPR analysis system of claim 1, wherein the apparatus control application comprises a module configured to display graphical user instructions for loading a flow cell in the SPR analysis apparatus.

19. The computer readable medium of claim 2, wherein the a graphical user interface module is configured to display a live video image of at least a portion of a microarray received from the SPR analysis apparatus.

20. The computer readable media of claim 19, wherein the graphical user interface module is configured to display a live sensorgram corresponding to selected regions of interest on the live video image.
